(19) United States
(12) Patent Application Publication
(10) Pub. No.: US 2004/0133448 A1
(43) Pub. Date: Jul. 8, 2004

(54) Content history log collecting system, terminal device and server device

(76) Inventors: Akio Higashi, Takatsuki-shi (JP); Mitsuhiro Inoue, Osaka-shi (JP); Katsumi Tokuda, Ikeda-shi (JP); Masanori Nakanishi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/738,303

(22) Filed: Dec. 18, 2003

(30) Foreign Application Priority Data
Dec. 20, 2002 (JP) 2002-370329

(51) Int. Cl. G06F 17/60

(52) U.S. Cl. 705/1

(57) ABSTRACT

The present invention is a system comprising a server device for providing a license and a terminal device for controlling the content use based on the license to be provided by the server, wherein the server device includes a database unit operable to store collection conditions concerning history logs to be collected in the terminal device, a generation unit operable to dynamically generate indication information that indicates history log collection to the terminal device according to the collection condition to be stored in the database unit, the first sending unit operable to send the generated indication information to the terminal device and the first receiving unit operable to receive the history logs to be sent from the terminal device as a response to the indication information, and the terminal device includes the second receiving unit operable to receive the indication information from the server device, a collection unit operable to collect content history logs according to the received indication information and the second sending unit operable to send the collected history logs to the server device.

### BACKGROUND OF THE INVENTION

(1) Field of the Invention

The present invention relates to a system for distributing digital contents such as video and music and a license for digital contents from a server device via a communication network or broadcasting and enabling a user to use the digital contents in a terminal device, especially a system and a device that allows a terminal device to collect content history logs according to use control of digital contents based on a license and send the history logs to the server device and allows a server to collect user's history logs of digital contents.

(2) Description of the Related Art

A system called content distribution system is in the stage of practical use recently, the content distribution system makes it possible to distribute digital contents such as music, video, game and the like from a server device to a terminal device via a communication network such as the Internet or digital broadcasting and use the contents using the terminal device. In generally-used content distribution systems, copy right protection technique is used so as to protect a copy right of digital contents and prevent unpermitted use of contents by a malicious user or others. More specifically, copy right protection technique is technique for securely controlling content use such as the case where a user plays back a content or copies it to a storage medium using encryption/decryption technique or the like.

Those systems includes a system that makes it possible to acquire content rating in a server device by acquiring history logs showing that its user used the content securely using the terminal device.

For example, in the patent literature 1 and the patent literature 2, a system for recording times and time of playing back contents or copying contents to a storage media and the like as history logs and periodically sending history logs to a specified server device is written as an example of a content history log collecting system.

In this way, in the conventional content history log collecting system, it is possible to send history logs such as content use times and time by a user to a server device.

[Patent Literature 1]

Japanese Laid-Open Patent application No. 2000-564425

[Patent Literature 2]

Japanese Laid-Open Patent application No. 2001-160003

However, conventional content history log collecting systems have problems like below.

First problem is that it is impossible to flexibly specify descriptions of history logs to be acquired by a terminal device, timing when a terminal device records history logs, upload timing by a server device and the like.

More specifically, it is possible to acquire history logs relating to brief operational descriptions such as content use times and time in a terminal device, but it is impossible to collect detailed history logs such as user operational descriptions (including special playback such as forwarding, rewinding and the like) when a user uses a content or whether a user viewed any particular part in the content or not. Also, it is impossible to make settings as to whether history logs are acquired for each user or for each content or not, or to flexibly specify a timing for recording history logs or sending the history logs to a server device concerning content type, a user profile and a policy on user security. Therefore, it is impossible to flexibly collect history logs according to the needs of service providers and various kinds of services.

Further, second problem is that a server device is deluged with accesses when sending history logs from terminal devices to a server device.

For example, it is easy to imagine the case where a server device is deluged with accesses for sending history logs from millions or thousands of users after a popular program, that is, a program that has a large number of viewers, is broadcast over the broadband network.

### SUMMARY OF THE INVENTION

The object of the present invention is to provide a server device, a terminal device and a system for flexibly collecting history logs according to the needs of service providers and a various kinds of services.

In order to achieve the above-mentioned object, a server device for providing a license to a terminal device for controlling content use based on the license, comprises: a database unit operable to store collection conditions concerning history logs to be collected in the terminal device; a generation unit operable to dynamically generate indication information according to the collection conditions stored in the database unit, the indication information indicating a request that the terminal device should collect history logs; a sending unit operable to send the generated indication information to the terminal device; and a receiving unit operable to receive history logs sent from the terminal device as a response to the indication information.

This construction has an effect that it is possible to flexibly collect history logs according to the needs of service providers and a various kinds of services because indication information dynamically generated in the server device according to collection conditions is sent from the server device to the terminal device and history logs are collected in the terminal device according to the indication information.

Here, the server device can be a server device wherein the database unit further stores a content use condition for each user of the terminal device, the server device further comprises a license issuing unit operable to issue a license for permitting a user to use the content according to the use condition stored in the use condition database unit, and the sending unit sends the license issued by the license issuing unit.

This construction enables the server device to dynamically generate indication information on collecting history logs when issuing a license according to the use condition or solely at any time.

Here, the server device can be a server device wherein the database unit stores collection conditions for each content, and the generation unit generates the indication information according to the collection conditions corresponding to the content permitted by the license issued by the license issuing unit.

Here, the server device can be a server device wherein the collection condition relates to a combination of at least two conditions selected from a content use date and time, played back part of a content in a whole content, a user operation for using a content, a user profile, a user terminal device ID, user's use state, a content use state and a content service providing state.

This construction makes it possible to dynamically generate indication information for each content permitted by each issued license. In addition, the indication information can indicate what kind of history logs should be collected and to what extent the descriptions of the history logs should be detailed.

Here, the server device can be a server device wherein the collection condition includes a selection condition for specifying the terminal device from which history logs should be collected, and

the generation unit generates indication information to the terminal device that satisfies the selection condition.

Here, the server device can be a server device wherein the selection condition includes at least one of an explicit specification of the terminal device, a random selection, a selection based on a user profile and a selection based on past history logs.

This construction makes it possible to dynamically select a terminal device that satisfies selection conditions and collect history logs from the selected terminal device instead of collecting history logs from all of the terminal devices equally.

Here, the server device can be a server device wherein the collection condition relates to a collection timing of history logs in the terminal device.

Here, the server device can be a server device wherein the collection timing includes at least one of at a certain time interval, for each content, for each unit of chapters that construct a content and for each user operation.

This construction makes it possible to dynamically generate indication information, for each content, that indicates the appropriate timing for collecting history logs in a terminal device.

Here, the server device can be a server device wherein the collection condition relates to a timing for sending history logs collected in the terminal device to the server device.

Here, the server device can be a server device wherein the sending timing includes at least one of at a certain time interval, when a license is returned, for one or more user operation and for a certain number of collection times.

Here, the server device can be a server device wherein the collection condition is prescribed in a way that sending timings from a plurality of user terminal devices are dispersed.

This construction makes it possible to dynamically indicate the appropriate timing for sending the history logs collected in the terminal device to the server device based on the indication information. Consequently, it becomes possible to disperse accesses from respective terminal devices to the server device.

Here, the server device can be a server device wherein the collection condition relates to a specification of the content whose history logs should be collection targets.

This construction makes it possible to dynamically specify contents to be collection targets of history logs.

Here, the server device can be a server device wherein the sending unit sends the indication information together with the license to the terminal device.

This construction makes it possible to send the indication information to the terminal devices together with the license.

Also, in order to achieve the above-mentioned object, the terminal device for controlling content use based on a license provided from a server device, comprises: a receiving unit operable to receive indication information from the server device; a collection unit operable to collect content history logs according to the received indication information; and a sending unit operable to send the collected history logs to the server device.

This construction has an effect that it is possible to flexibly collect history logs according to the needs of service providers or various kinds of services because the terminal device collects history logs with descriptions which are dynamically specified by the indication information instead of collecting history logs whose descriptions are invariably identical.

Here, the terminal device can be a terminal device wherein the indication information includes at least two conditions selected from a content use date and time, played back part of a content in a whole content, a user operation for using a content, a user profile, a user terminal device ID, user's use state, a content use state and a content service providing state.

This construction enables the terminal device to dynamically switch collection targets such as what kind of history logs should be collected and to what extent the descriptions of the history logs should be detailed for each content according to the indication information.

Here, the terminal device can be a terminal device wherein the indication information includes a collection timing of history logs in the terminal device, and the collection unit collects the history logs according to the collection timing.

This construction enables the terminal device to dynamically switch timings appropriate for collecting history logs.

Here, the terminal device can be a terminal device wherein the indication information includes a sending timing for sending history logs collected in the terminal device to the server device, and the sending unit sends the history logs according to the sending timing.

This construction enables the terminal device to dynamically switch timings appropriate for sending the collected history logs to the server device. Consequently, it becomes possible to disperse accesses from the respective terminal devices to the server device.

Here, the terminal device can be a terminal device wherein the terminal device further comprises a database unit operable to store history logs collected by the collection unit securely, and the sending unit sends the history logs stored in the database unit securely.

This construction enables the terminal device to protect privacy because it securely stores and sends history logs together with license tickets.

Here, the terminal device can be a terminal device wherein the indication information is sent from the server device together with a license for permitting the content use, and the collection unit collects the history logs concerning content use permitted by the license.

This construction enables the terminal device to cut unnecessary communication and receive information securely because it receives the indication information together with the license.

Also, the system capable of achieving the above-mentioned object includes the server device and the terminal device, and thus the system has the same construction, action and effect as the above-mentioned devices.

Likewise, the history log collecting method and program that makes it possible to achieve the above-mentioned object are the same as the devices.

### FURTHER INFORMATION ABOUT TECHNICAL BACKGROUND TO THIS APPLICATION

filed, is incorporated herein by reference.

Japanese Patent application No. 2002-370329 filed Dec. 20, 2002.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram showing the outline construction of the whole content history log collecting system 1 concerning the embodiment of the present invention.

FIG. 2 is a functional block diagram showing the constructions of a right management server 101b and a terminal device 102 concerning the first embodiment of the present invention.

FIG. 3 is a diagram showing the table construction of a user information DB 201 concerning the first embodiment of the present invention.

FIG. 4 is a diagram showing the table construction of a content key DB 202 concerning the first embodiment of the present invention.

FIG. 5 is a diagram showing the table construction of a use condition DB 203 concerning the first embodiment of the present invention.

FIG. 6 is a diagram showing the table construction of a history log collection condition DB 204 concerning the first embodiment of the present invention.

FIG. 7 is a diagram showing the table construction of a history log collection condition DB 205 concerning the first embodiment of the present invention.

FIG. 8 is a diagram showing the construction of an LT 800 concerning the first embodiment of the present invention.

FIG. 9 is a diagram showing the construction of a tag block for indicating history log collection 804 concerning the first embodiment of the present invention.

FIG. 10 is a diagram showing the construction of an ELI 1000 concerning the first embodiment of the present invention.

FIG. 11 is a diagram showing the construction of an LT 800 including history logs concerning the first embodiment of the present invention.

FIG. 12 is a diagram showing the construction of a tag block for indicating history log collection 1105 concerning the first embodiment of the present invention.

FIG. 13 is a flow chart showing the processing for acquiring an LT 800 from a right management server 101b by the terminal device 102 concerning the first embodiment of the present invention.

FIG. 14 is a flow chart showing LT issuability judgment processing in the right management server 101b concerning the first embodiment of the present invention.

FIG. 15 is a flow chart showing generation processing of history log collection indication in the right management server 101b concerning the first embodiment of the present invention.

FIG. 16 is a flow chart showing recording processing of content use and history logs in the terminal device 102 concerning the first embodiment of the present invention.

FIG. 17 is a flow chart showing history log recording processing in the terminal device 102 concerning the first embodiment of the present invention.

FIG. 18 is a flow chart showing sending processing of history logs from the terminal device 102 to the right management server 101b concerning the first embodiment of the present invention.

FIG. 19 is a functional block diagram showing the construction of the terminal device 102 concerning the second embodiment of the present invention.

FIG. 20 is a diagram showing the table construction of a history log collection condition DB 204 concerning the second embodiment of the present invention.

FIG. 21 is a flow chart showing generation processing of history log collection indication in the right management server 101b concerning the second embodiment of the present invention.

FIG. 22 is a flow chart showing the history log record processing in the terminal device 102 concerning the second embodiment of the present invention.

FIG. 23 is a flow chart showing sending processing of history logs from the terminal device 102 to the right management server 101b concerning the second embodiment of the present invention.

FIG. 24 is a flow chart showing sending processing of an LT 800 from the second terminal device 102 to the first terminal device 102 concerning the second embodiment of the present invention.

FIG. 25 is a diagram showing the construction of an LT 2500 including history logs concerning the second embodiment of the present invention.

### DESCRIPTION OF THE PREFERRED EMBODIMENT(S)

(First Embodiment)

The first embodiment of the present invention will be explained in detail below with reference to figures.

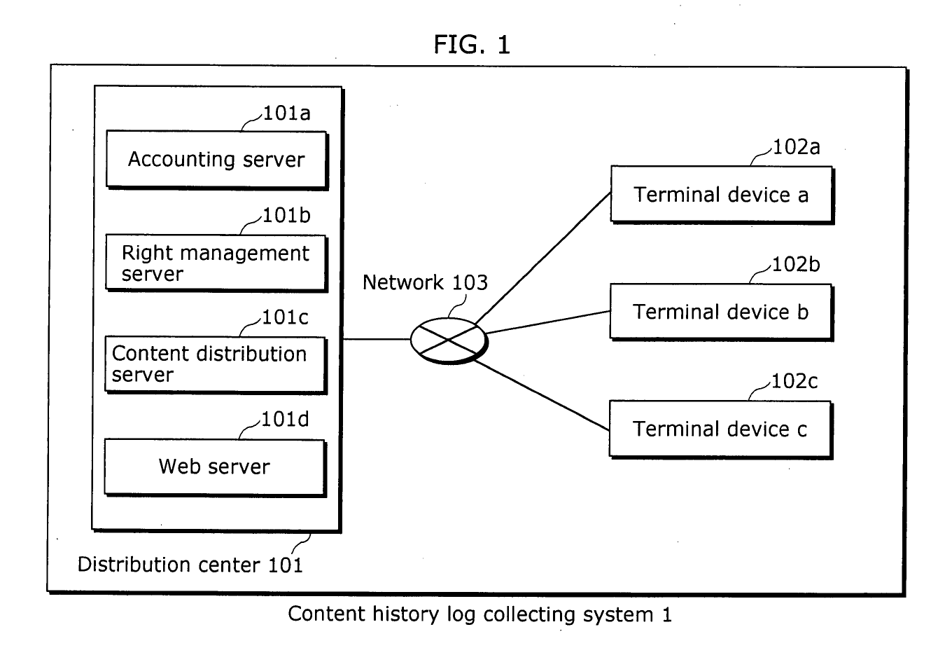

FIG. 1 is a diagram showing the outline construction of the whole content history log collecting system 1 in the first embodiment of the present invention.

This content history log collecting system 1 comprises a distribution center 101 for distributing contents or the like, terminal devices 102a to 102c for using contents, a network 103 for connecting them to each other. Users of respective terminal devices use digital contents, in a terminal device, that is distributed from a distribution center (that is, a service provider) via a network or a recording medium or the like.

The distribution center 101 comprises an accounting server 101a for charging users, a right management server 101b for managing use rights (use conditions) of the contents owned by a user, generates content licenses and distributes contents to terminal devices 102a to 102c, a content distribution server 101c for distributing contents, a web server 101d for sending a web display screen for providing various kinds of services to terminal devices 102a to 102c via a network 103.

The accounting server 101a is a server device for charging on-line when purchasing content use conditions and the like via the Internet or the like. More specifically, the accounting server 101a charges a rate to a credit card or accepts payments by credit card or registers user's bank account number in advance in the accounting server 101a and charges rate to the bank account or accepts payments by bank transfer based on the purchase history and the like uploaded from the terminal devices 102a to 102c via the network 103.

The right management server 101b is a server device for managing the content use conditions owned by a user and giving the user the license for the content. More specifically, the right management server 101b manages the content use conditions owned by each user or each of terminal devices 102a to 102c and distributes these licenses to terminal devices 102a to 102c via the network 103. Also, in a push-style distribution such as digital broadcasting, broadband broadcasting or the like, it is possible to use a content by distributing a temporally invalidated license together with the content and validating licenses by performing charging processing in terminal devices 102a to 102c.

Note that a license comprises a decryption key (content key) for decrypting an encrypted content, use conditions such as a content validated period or available times and the like, and it is data called a license ticket (written as “LT” from here). When sending and receiving data such as an LT between the distribution center 101 and terminal devices 102a to 102c via the network 103, a secure authenticated channel (written as SAC) is established so as to ensure security and then the data is received and sent via the SAC. Data construction of an LT will be explained in detail later with reference to a figure.

Also, a generally-used encryption algorithm for encrypting a content is a common key encryption algorithm such as the advanced encryption standard (AES), the data encryption standard (Triple DES) and the like.

The content distribution server 101c is a server device for distributing a content to terminal devices 102a to 102c via the network 103, and it is realized in a form of workstation or the like. More specifically, the content distribution server 101c is digitally compressed using a compression method such as the moving picture experts group (MPEG-2), MPEG-4 or the like and distributes contents encrypted using AES, Triple DES or the like if necessary.

For example, in the case of the Internet, it can be a server device that performs streaming of contents using a protocol such as the Realtime Transfer Protocol (RTP)/the User Datagram Protocol (UDP) or the like or a server device that provides download contents using a protocol such as the File Transfer Protocol (FTP), the HyperText Transfer Protocol (HTTP) or the like. Also, in the case of digital broadcasting, it can be a transmitting device for providing stream style contents using the MPEG-2 Transport Stream (TS) or can be a transmitting device for providing storage type contents based on a data carousel transmission method shown in the Association of Radio Industries and Businesses (ARIB) STD-B24 and the like.

The web server 101d provides a display screen for enabling a user of the content purchase display screen or the like to access various kinds of services from terminal devices 102a to 102c. More specifically, the web server 101d provides web pages written in script language such as the HyperText Markup Language (HTML), the Extensible Markup Language (XML) or the like using a protocol such as HTTP or the like via the Internet or pages written in Broadcasting Markup Language (BML) in digital broadcasting.

The network 103 is a network that alternately connects the distribution center 101 and terminal devices 102a to 102c. For example, the network 103 is a network of a communication network such as the Internet, digital broadcasting or a multiplexed network of those listed earlier.

Terminal devices 102a to 102c have a function for connecting with the network 103 and are a terminal device for enabling a user to use contents on a monitor display screen or write contents in a storage medium. More specifically, terminal devices 102a to 102c are any of a set top box (STB) for receiving digital broadcasting, a digital TV, a digital versatile disc (DVD) recorder, a hard disk drive (HDD) recorder, a content displaying device such as a personal computer (PC), a recorder or a multiplexed device of those listed earlier.

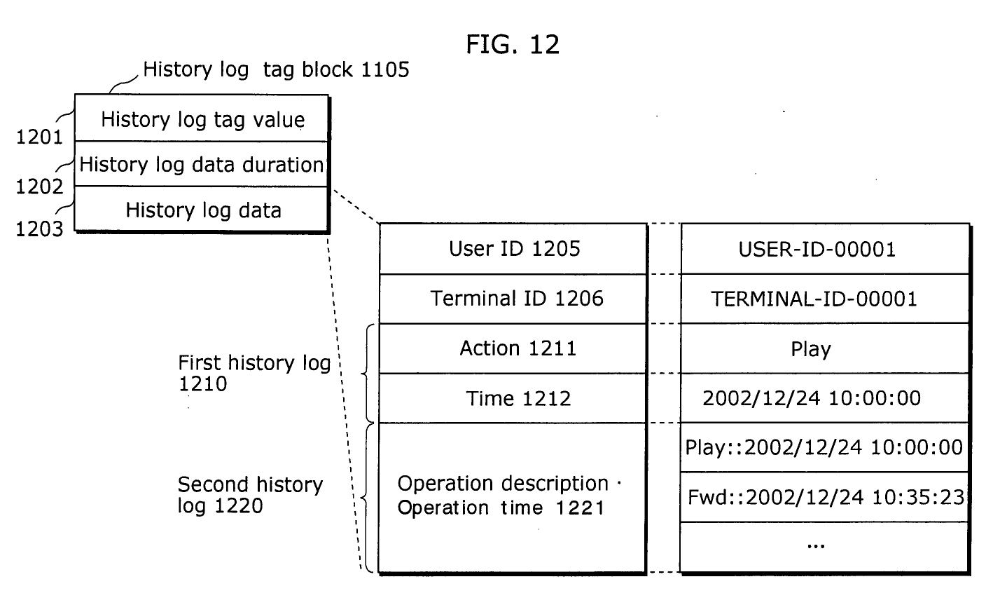

In the content history log collecting system 1 like this, detailed explanations on the processing for distributing contents or licenses via the network 103, using contents in terminal devices 102a to 102c, recording content history logs and sending history logs from terminal devices 102a to 102c to the distribution center 101 will be made with reference to FIGS. 12 to 18. Note that the following example is the case where the right management server 101b in the distribution center 101 indicates a request that terminal devices 102a to 102c should collect history logs using LTs and collects content history logs from terminal devices 102a to 102c using these LTs.

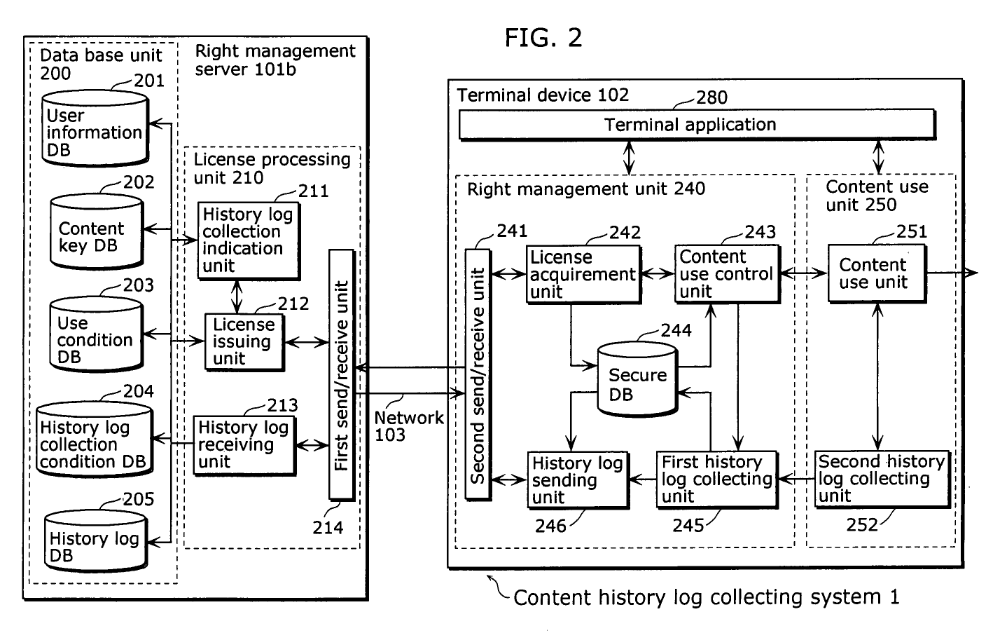

FIG. 2 is a functional block diagram showing the detailed construction of the right management server 101b in the distribution center 101 shown in FIG. 1 and terminal devices 102a to 102c. Explanation on the detailed construction of the distribution center 101 excluding the right management server 101b shown in FIG. 1 is omitted because it needs not to be focused on here. The terminal device 102a is chosen to show the functional constructions of terminal devices 102a to 102c as a terminal device 102. Also, a network 103 is shown in FIG. 2.

The right management server 101b comprises, roughly in parts, a database unit 200 that is realized in a data file or the like stored in an HDD or the like and a license processing unit 210 that is realized in a program or the like to be executed using a hardware such as an LSI, a RAM, a ROM or the like. On the other hand, the terminal device 102 comprises a right management unit 240 operable to process licenses and performs content use control securely, a content use unit 250 operable to use contents securely and a terminal application 280 for providing an interface to users as a main function.

First, detailed construction of the right management server 101b will be explained.

A database unit 200 in the right management server 101b comprises a user information DB 201, a content key DB 202, a use condition DB 203, a history log collection condition DB 204, and a history log DB 205. Also, the license processing unit 210 comprises a history log collection indication unit 211, a license issuing unit 212, a history log receiving unit 213 and the first sending and receiving unit 214.

The user information DB 201 is a database unit that has a user information management table for managing information on users and is used for associating the terminal device 102 for accessing the right management server 101b with respective users who own the content use conditions which are managed in the use condition DB 203.

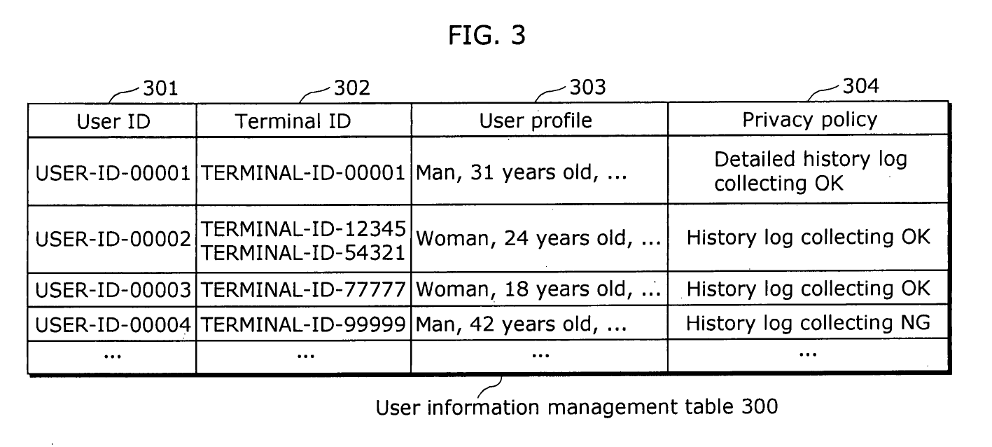

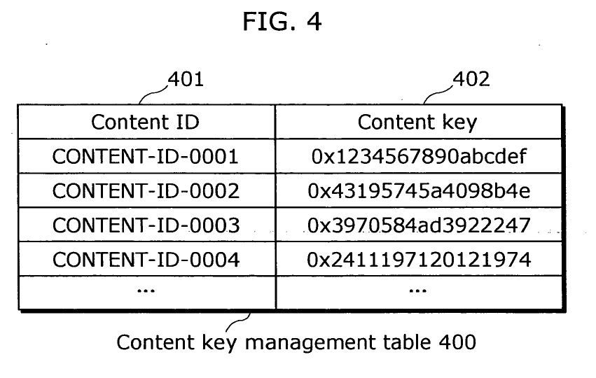

More specifically, the user information DB 201 has a user information management table 300 shown in FIG. 3 and manages a user ID 301 for identifying a user in the content history log collecting system 1, a terminal ID 302 for identifying a terminal device 102 in the content history log collecting system 1, a user profile 303 for showing detailed information on users and a privacy policy 304 for showing each user's policy on history log collection.

Here, the user profile 303 shows registered user information such as user's name, age, sex, address, favorite programs, hobbies and so on and can be used for choosing users whose history logs are to be collected and can also be used as a judgmental standard for analyzing user's content use tendency based on the relationship between user's favorite program and a program collected as history logs.

Also, the privacy policy 304 is information showing whether a user permits a service provider to use part or all of his or her content history logs or not and is for realizing history logs according to each user's intention on privacy.

For example, in FIG. 3, it is shown that a user whose user ID 301 is “USER-ID-00001” owns a terminal device 102 whose terminal ID 302 is “TERMINAL-ID-00001”. Also, a user profile 303 shows that a user whose user ID is “USER-ID-00001” is a man of 31 years old, and that he permits his service provider to collect his content history logs in the terminal device 102 in detail because his privacy policy 304 reads “Detailed history log collecting OK”. Here, detailed history logs mean detailed user operation descriptions and the like concerning the content used by the user in the terminal device 102, these history logs are information concerning the played back part of the content, special playback such as forwarding and rewinding or the like.

Also, a user whose user ID 301 is “USER-ID-00002” owns two terminal devices 102 whose terminal IDs 302 are “TERMINAL-ID-12345” and “TERMINAL-ID-54321” respectively, which shows that she can access the right management server 101b from any of terminal devices 102.

Also, the privacy policy 304 of a user whose user ID is USER-ID-00002” reads “History log collecting OK”, which shows that she permits her service provider to collect transaction-level history logs such as content playback or copy times in the terminal 102 although she does not permit the service provider to collect detailed content history logs in the terminal device 102 like a user whose user ID is “USER-ID-00001” does. In contrast, the privacy policy 304 of a user whose user ID is USER-ID-00004” reads “History log collecting NG”, which shows that he does not permit his service provider to collect content history logs.

Note that data is registered to the user information DB 201 when a service provider registers a user as a member to provide services. A user can be perform this member registration processing on-line between the distribution center 101 and the terminal device 102 using a member registration display screen which is provided by a web server 101d via the network 103 or off-line using a postcard for member registration or the like. In the member registration processing, a service provider assigns a user a user ID 301 first. After that, as a terminal ID 302 of a user terminal device 102 is sent to the service provider on-line or off-line, the user ID 301 is associated with the terminal device ID 302 and these IDs are registered in the user information management table 300 of the user information DB 201. As a result from performing member registration processing like shown above, a user information DB 201 is established. Note that the terminal ID 302 is an ID managed in the terminal device 102, however, when the right management unit 240 is detachable from the terminal device 102, it is possible to use the ID capable of identifying the right control unit 240 in the content history log collecting system 1 as the terminal ID 302.

The content key DB 202 is a database unit operable to manage content keys for decoding encrypted contents, is used for acquiring a content key corresponding to a content ID included in an LT acquirement request when generating an LT as a response to a license acquirement request (an LT acquirement request) from the terminal device 102.

More specifically, the content key DB 202 owns a content key management table 400 comprising a content ID 401 for identifying a content in the content history log collecting system 1 and a content key 402 corresponding to content ID 401.

For example, the content key needed for decrypting the encrypted content whose content ID 401 is “CONTENT-ID-00001” is the one whose content key ID 402 is “0x1234567890abcdef”.

The use condition DB 203 is a database unit operable to manage content use conditions for each user and is used for generating an LT when it judges that the LT acquirement request from the terminal device 102 satisfies user's use condition.

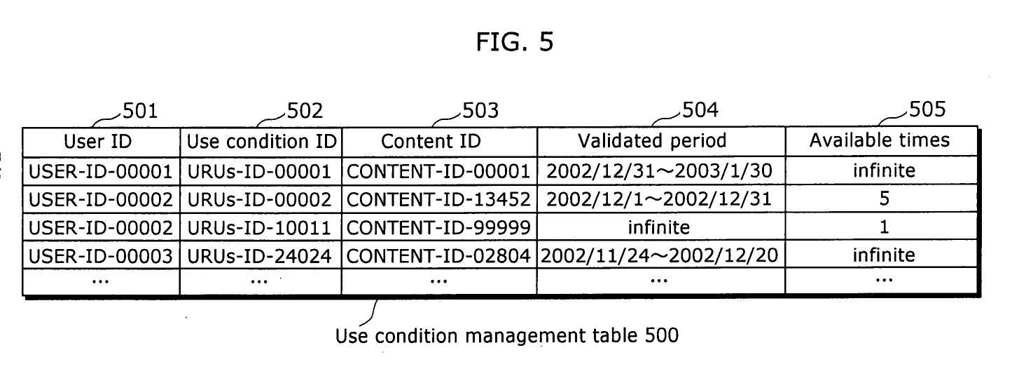

More specifically, the use condition DB 203 identifies a user in the content history log collecting system 1 as shown in FIG. 5 and owns a use condition management table 500 comprising a user ID 501 showing the owner of the use condition, a use condition ID 502 for identifying a use right owned by a user shown by the user ID 501, a content ID 503 for identifying a content to be made available by a use condition in the content history log collecting system 1, a validated period 504 showing starting and finishing date and time for using the content shown by the content ID 503 and an available times 505 showing content available times shown by the content ID 503.

For example, a user whose user ID 501 is “USER-ID-00001” holds a use condition of “URUs-ID-00001” as a use condition ID 502. The use condition “URUs-ID-00001” is a content of “CONTENT-ID-00001” shown by the content ID 503 as a content to be made available, the validated period 504 is “2002/12/31 to 2003/1/30” and the available times 505 is infinite, that is, it can be used unlimitedly. Also, a user whose user ID 501 is “USER-ID-00002” owns two use conditions of “URUs-ID-00002” and “URUs-ID-10011” as the use condition ID 502. The use condition “URUs-ID-00002” out of these two is a use condition corresponding to a content whose content ID 503 is “CONTENT-ID-13452”, the validated period 504 is “2002/12/1 to 2002/12/31”, the available times 505 is “5 times”, which shows that the content is available up to 5 times during the validated period. Also, the use condition “URUs-ID-10011” is a content use condition of “CONTENT-ID-99999” as the content ID 503, the validated period 504 is infinite but the content available times is only “1 time” as shown by the available times 505.

The history log collection condition DB 204 is a database operable to manage conditions for indicating history log collection to the terminal device 102, manages data such as conditions concerning which users history logs should be collected, timing for recording history logs in the terminal device 102, timing for sending history logs from the terminal device 102 to the right management server 101b, descriptions of history logs to be recorded and the like specific for each content and is used when indicating a history log collection to the terminal 102.

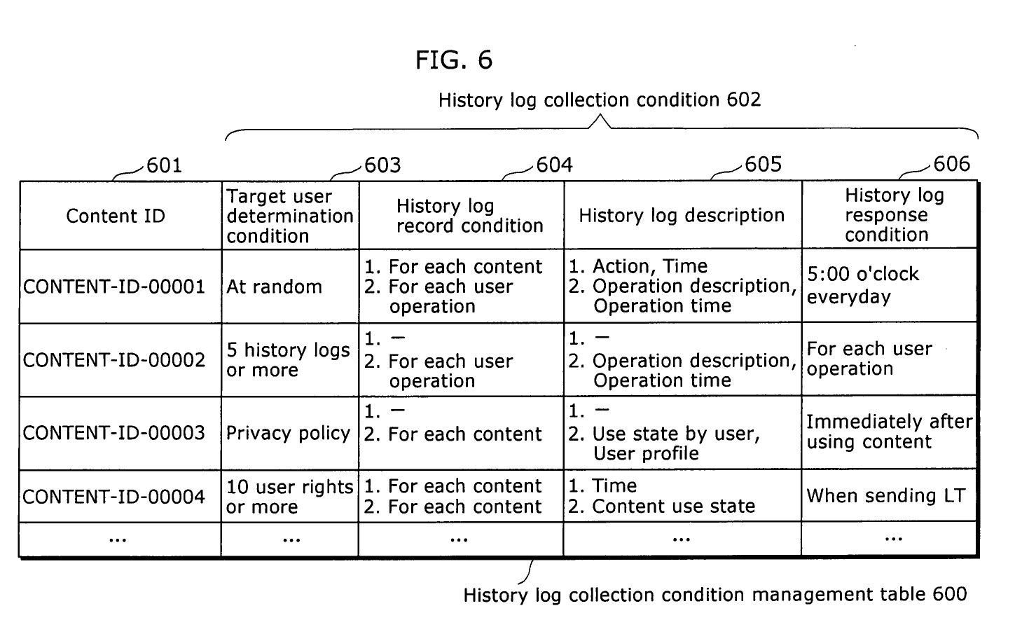

More specifically, the history log collection condition DB 204 has a history log collection condition management table 600 comprising a content ID 601 for identifying a content in the content history log collecting system 1 and a history log collection condition 602 showing conditions for determining users whose history logs are to be collected and conditions on timings for history log collection and descriptions of history logs as shown in FIG. 6. The history log collection condition 602 includes a target user determination condition 603 showing conditions for determining users whose history logs are to be collected, a history log record condition 604 showing conditions for recording history logs, a history log description 605 showing articles (descriptions) of history logs to be recorded and a history log response condition 606 showing conditions for sending the recorded history logs from the terminal device 102 to the right management server 101b.

For example, as to the content whose content ID 601 is “CONTENT-ID-00001”, users whose history logs are to be collected or terminal devices 102 are determined “at random” as shown by the target user determination condition 603. Also, the settings of the history log record condition 604 are “1. for each content” and “2. for each user operation”. This means “1. for each content” is a history log record condition to the content use control unit 243 and “2. for each user operation” is a history log record condition to the content use unit 251. The use control unit 243 and the content use unit 251 indicate acquiring history logs based on the respective history log record conditions. In other words, it is indicated that the content use control unit 243 should record history logs “for each content” and that the content use unit 251 records history logs “for each user operation”. Likewise, as the settings of the history log description 605 are “1. action, time” and “2. operation description, operation time”, the content use control unit 243 records “action” and “time” when the action is made, and the content use unit 251 records detailed user “operation descriptions” such as playback, forwarding and the like and “operation time”. Further, the setting of the history log response condition 606 is “5:00 o'clock everyday”, which indicates that the registered history logs are sent to the right management server 101b at 5:00 o'clock everyday. As mentioned up to this point, the setting of the history log collection condition 602 of the content “CONTENT-ID-00001” are as follows: target users whose history logs are to be collected are determined “at random” from the user information DB 201, the determined users indicate that the content use control unit 243 records “action” and “time” when the action is made “for each content”, the determined users indicate that the content use unit 251 record user's “operation descriptions” and the “operation time” “for each user operation” and the recorded history logs are sent to the right management server 101b at “5:00 o'clock everyday”. Here, a conceivable method for determining users whose history logs are to be collected at random is, for example, a method of generating random numbers using random number or the like and choosing users corresponding to user IDs 301 (such as 5-digit numbers following “USER-ID-”) in the user information management table 300 of the user information DB 201 corresponding to these random numbers.

Also, as the target user determination condition 603 of the content whose content ID 601 is “CONTENT-ID-00002” reads “5 history logs or more”, users whose history logs are to be collected are determined on condition that the users have 5 or more history logs in the past when referring to the history log DB 205 at the time of issuing an LT. Also, as shown by the history log record condition 604 of the “CONTENT-ID-00002” which reads “1.-” “2. for each user”, the collection condition is an example indicating that the content use control unit 243 does not acquire history logs and that only the content use unit 251 records history logs for each user operation, in other words, each time a user performs an operation such as playback, stop, pause, forwarding and so on. Also, as shown by the history log response condition 606 of the “CONTENT-ID-00002” which reads “for each user operation”, history logs are sent from the terminal device 102 to the right management server 101b when one or plural number of user operations are performed.

Further, in the case of a content whose content ID 601 is “CONTENT-ID-00003”, as its target user determination condition 603 reads “privacy policy”, judgment on whether the user makes a target user whose history logs are to be collected or not is made according to the user privacy policy by referring to the user information DB 201. The history log description 605 of “CONTENT-ID-00003” indicates that “use state by user” and “user profile” should be collected.

“Use state by user” shows how the user uses the content in the terminal device 102, to put it more specifically, user's way of viewing the content such as viewing the content real time, viewing the content recorded by manual reservation recording, viewing the content recorded by automatic reservation recording and the like. Also, the user profile is information on the user such as user's age, sex, hobbies and the like set by the user in the terminal device 102.

Note that the history log response condition 606 of the content whose content ID is “CONTENT-ID-00003” reads “immediately after using content” and thus it is an example indicating that history logs should be sent from the terminal device 102 to the right management server 101b when finishing using the content.

Also, in the case of a content whose content ID is “CONTENT-ID-00004”, its target user determination condition 603 reads “10 or more user records” indicating that only history logs of users who has 10 or more records of use conditions should be collected in the use condition DB 203. Also, the history log description 605 reads “1. time” “2. content use state” indicating that the content use control unit 243 records “time” when the action is performed and the content use unit 251 records “content use state”. Here, content use state shows mainly content quality such as content resolution, sound channel (such as 2ch playback or 5.1ch playback) and the like. Also, the history log response condition 606 reads “when sending LT” indicating that history logs should be collected when sending one or plural numbers of LTs. Sending history logs together with a license from a terminal device to a server device makes it possible to identify a license with which a user used a content in a highly reliable way.

In this way, a plurality of conditions can be set as the history log collection condition 602 of a content ID 601 as shown in FIG. 6. In other words, collection conditions can be set on history logs to be recorded by the right management unit 240 and the content use unit 250 respectively.

The history log DB 205 is a database operable to store history logs collected from the terminal device 102 via the network 103.

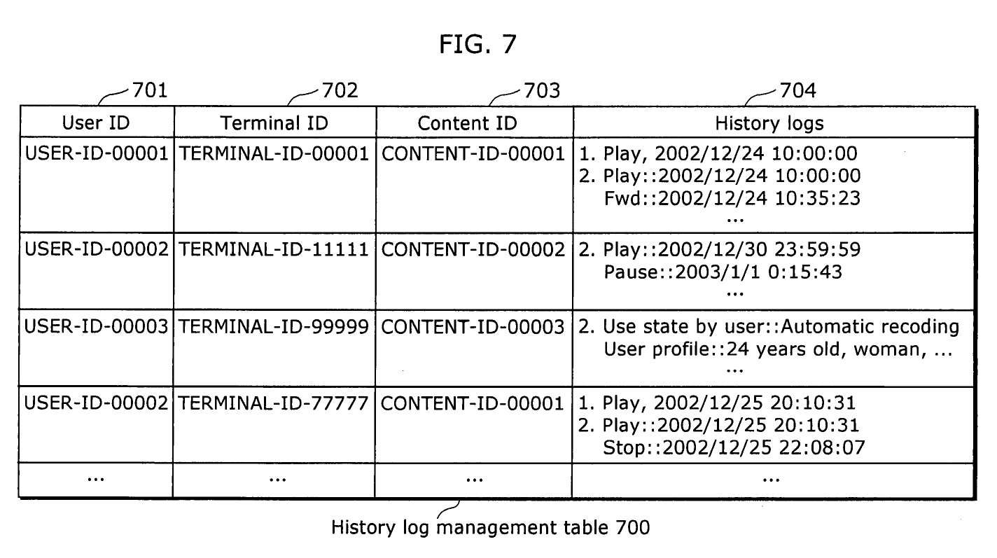

More specifically, the history log DB 205 has a history log management table 700 comprising a user ID 701 for identifying a user who used the content and whose history logs were sent, a terminal ID 702 for identifying the terminal device 102 that recorded the history logs, a content ID 703 for identifying the content used by the users and a history log 704 showing the descriptions of the history logs collected from the terminal device 102 as shown in FIG. 7.

For example, the terminal ID 702 and the content ID 703 of a user whose user ID 701 is “USER-ID-00001” shows that the content of “CONTENT-ID-00001” was used in the terminal device 102 of “TERMINAL-ID-00001”, its history log 704 shows following examples: “1. Play, 2002/12/24 10:00:00” showing the action acquired by the content use control unit 243 and the time when the action is conducted, “2. Play :: 2002/12/24 10:00:00” showing detailed user operation descriptions and the time when the operation is performed acquired by the content use unit 251, “Fwd:: 2002/12/24 10:35:23” and the like. Likewise, as to the history logs of a user whose user ID 701 is “USER-ID-00002”, the detailed user operations are recorded as follows: the content of “CONTENT-ID-00002” is used in the terminal of “TERMINAL-ID-11111”, the history log acquired in the content use unit 251 of the terminal device 102 is recorded as “Play :: 2002/12/30 23:59:59” and the following user operation description and the time is recorded as “Pause :: 2003/1/1 0:15:43”. Further, as the history logs of a user whose user ID 701 is “USER-ID-00003”, information indicating that “automatic recording is performed as the user use state, that the user is a woman of 24 years old as the user profile and the like are recorded.

The history log collection indication unit 211 generates indication information for indicating history log collection to the terminal device 102.

More specifically, the history log collection indication unit 211 generates indication information for history log collection using a user information DB 201, a use condition DB 203, a history log collection condition DB 204, a history log DB 205 and the like as necessary when receiving an LT issuing request from a user and sends the indication information to a license issuing unit 212 so as to make it an LT.

The license issuing unit 212 generates an LT in response to the LT issuing request from the terminal device 102.

More specifically, the license issuing unit 212 uses the user information DB 201, the content key DB 202 and the use condition DB 203 in response to the LT issuing request from the terminal device 102 and performs processing for generating an LT on condition that the LT issuing request satisfies the user use condition or not. Also, the license issuing unit 212 receives indication information for history log collection form the history log collection indication unit 211 so as to indicate that user history logs of contents should be collected from the right management server 101b to the terminal device 102 and sets the indication information as the LT.

The history log receiving unit 213 receives history logs to be collected from the terminal device 102 and writes the received history logs in the history log DB 205.

More specifically, when the first sending and receiving unit 214 receives the LT sent from the terminal device 102, the history log receiving unit 213 acquires the history logs included in the LT and registers the history logs in the history log management table 700 in the history log DB 205. Also, the history log receiving unit 213 processes the returned LT 800 as necessary and reflects the results in the user information DB 201, the use condition DB 203, the history log collection condition DB 204 or the like.

The first sending and receiving unit 214 communicates with the terminal device 102 via the network 103.

Up to this point, detailed construction of the right management server 101b has been explained.

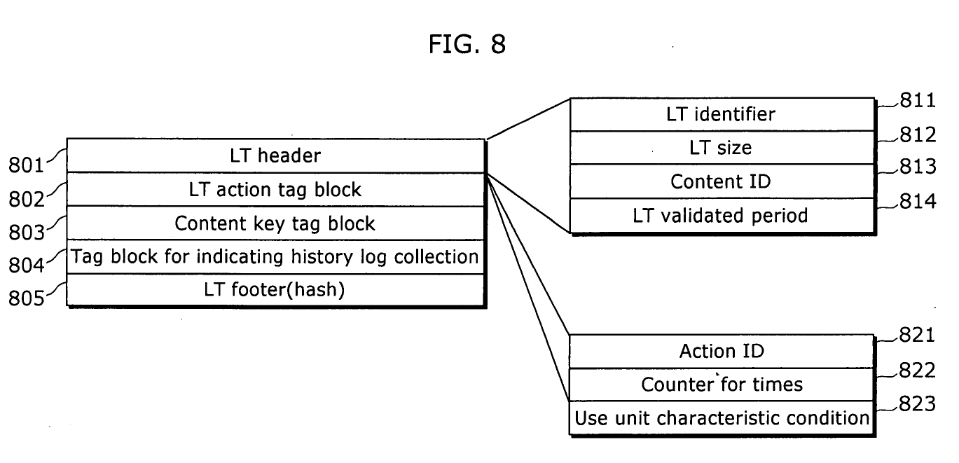

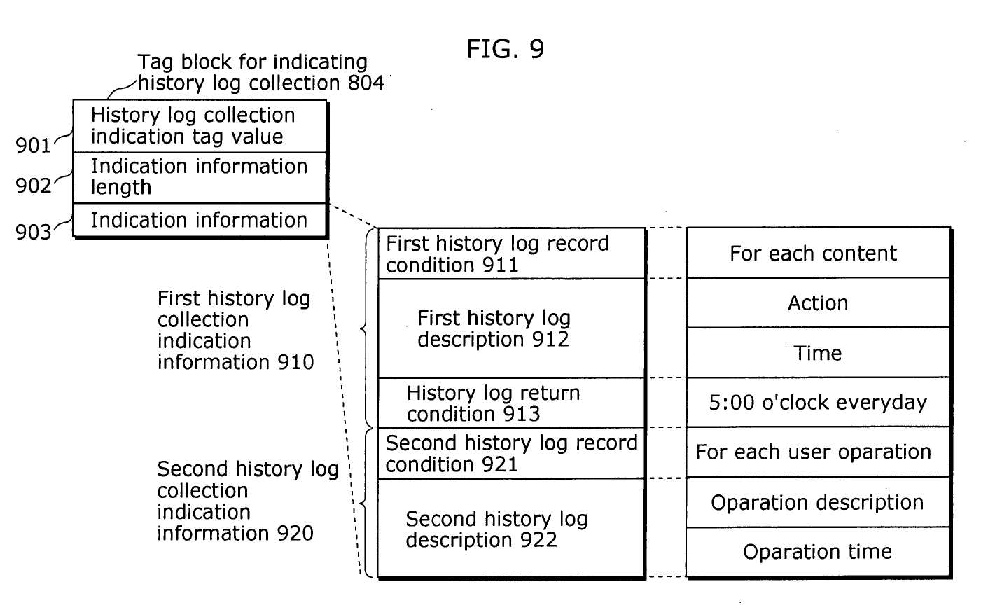

Here, constructions of the indication information for collecting LTs to be issued by the license issuing unit 212 and history logs to be generated by the history log collection indication unit 211 will be explained in detail with reference to FIGS. 8 and 9.

FIG. 8 is a diagram showing an example of an LT construction. The LT 800 shown in FIG. 8 comprises a content ID of a content to be made available by the LT 800, an LT header 801 including the validated period of the LT 800 and the like, an LT action tag block 802 showing use conditions such as available times of playing back contents and copying contents in a storage medium, a content key tag block 803 including a content key for decrypting a content, a tag block for indicating history log collection 804 for indicating history log collection from the right management server 101b to the terminal device 102, an LT footer 805 as a hash value for detecting manipulation of the LT 800.

The LT header 801 comprises an LT identifier 811 for identifying the LT 800, an LT size 812 showing the length of the whole LT 800, a content ID 813 as an identifier of the content to be made available by the LT 800 and an LT validated period 814 showing the validated period of the LT 800.

The LT action tag block 802 comprises an action ID 821 for identifying a user action corresponding to the content such as “playback”, “copy”, “print” or the like, a counter for times 822 showing the available times of action execution and a use unit characteristic condition 823 showing characteristic use conditions of the content use unit 251. Here, the use unit characteristic condition 823 is use conditions depending on the type or performance of the content use unit 250 in the terminal device 102 and shows the one which can be interpreted only by the content use unit 250, for example, sound channel indication of a movie content (it can be played back on 5.1 ch or 2ch) or the resolution of the image content, the size indication and the like.

A content key for decrypting the encrypted content is set using a binary value in the content key tag block 803.

The tag block for indicating history log collection 804 is a tag block to be generated in the history log collection indication unit 211 and has a format shown in FIG. 9. The tag block for indicating history log collection 804 comprises a history log collection indication tag value 901 that is an identifier for identifying the tag block for indicating history log collection 804, an indication information length 902 showing the length of the tag block for indicating history log collection 804 and an indication information 903 of information indicating history log collection.

The indication information 903 comprises the first history log collection indication information 910 which is used by the right management unit 240 in the terminal device 102 and the second history log collection indication information 920 to be used by the content use unit 250. The first history log collection indication information 910 includes the first history log record condition 911, the first history log description 912, a history log response condition 913. Here, it shows indications to the content use control unit 243 of the right management unit 240 as follows: “for each content” of the first history log record condition 911 is an indication for recording history logs for each unit of contents to be used, “action” and “time” of the first history log description 912 of the first history log description 912 are indications for recording actions showing descriptions of operations for using contents (such as playback, copy and the like) and the time when these actions are performed, “5:00 o'clock everyday” of the history log response condition 913 is an indication for sending the recorded history logs on the contents to the right management server 101b at 5:00 o'clock everyday. On the other hand, the second history log collection indication information 920 comprises the second history log record condition 921 and the second history log description 922. Here, it shows indications to the content use unit 251 as follows: “for each user operation” of the second history log record condition 921 is an indication for recording history logs for each user operation on the content and the second history log description 922 shows indications for recording more detailed user operation descriptions and user operation time than indicated in the first history log description 912.

Note that conditions used only by the right management unit 240 has been shown as an example concerning the history log response condition 913 here, but conditions are not limited to the example, for example, conditions used by the content use unit 250 can be set.

The LT footer 805 detects a manipulation and ensures the authenticity of the LT 800 when storing an LT 800 in an insecure part in a hard disk or the like, and it counts the hash value of the LT 800 and manages the calculation result each time the contents of the LT is updated. This hash value needs to be managed in the tamper-proof part at a hard disk level. As to a specific hash algorithm, Secure Hash Algorithm (SHA-1) or the like is used.

Up to this point, explanations on the detailed constructions of the LT 800 and the tag block for indicating history log collection 804 as indication information for history log collection have been made with reference to FIGS. 8 and 9.

Next, detailed construction of the terminal device 102 will be explained.

The terminal device 102 comprises a right management unit 240 operable to perform content use control securely, a content use unit 250 operable to use contents securely and a terminal application 280 for providing a user with an interface.

The right management unit 240 comprises the second sending and receiving unit 241, a license acquirement unit 242, a content use control unit 243, a secure DB 244, the first history log collection unit 245 and a history log sending unit 246.

The second sending and receiving unit 241 communicates with the distribution center 101 via the network 103.

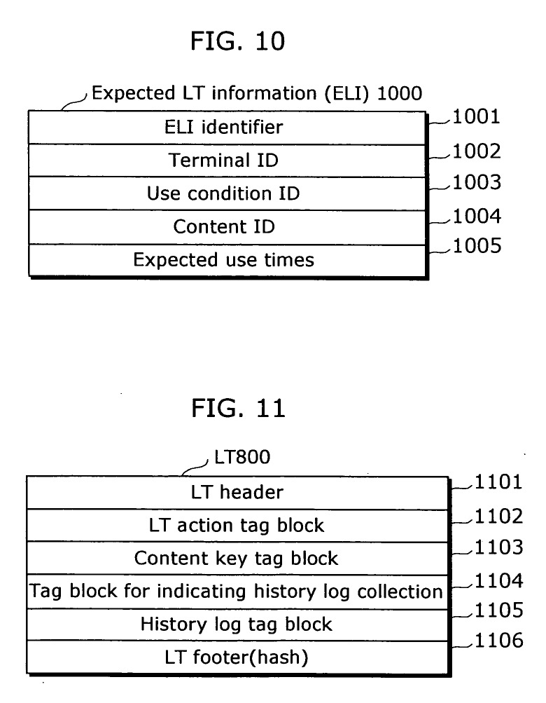

The license acquirement unit 242 acquires an LT 800 from the right management server 101b. More specifically, the license acquirement unit 242 generates expected LT information (written as ELI from here) 1000 shown in FIG. 10 and acquires the LT 800 from the right management server 101b by sending the ELI 1000 to the right management server 101b.

In the FIG. 10, the ELI 1000 comprises an ELI identifier 1001, a terminal ID 1002, a use condition ID 1003, a content ID 1004 and an expected use times 1005. In the ELI identifier 1001, information showing that the data is ELI 1000 is written. In the terminal ID 1002, a terminal ID of the terminal device 102 which generated the ELI 1000, that is, the terminal ID of the terminal device 102 which requests for the LT 800 is written. The use condition ID 502 for identifying user use condition to be managed in the use condition DB 203 of the right management server 101b is written in the use condition ID 1003. A use condition ID to be sent as a response when a user makes an inquiry on the available right from the right management server 101b is used as this use condition ID 502. In the content ID 1004, the content ID of the desired content is written in the content ID 1004. In the expected use times 1005, the value of available times of the content to be set in the counter for times 822 in the LT action tag block 802 of the LT 800 to be requested is written. Note that it is possible to request the validated period of the LT desired by the user (the LT validated period 814 in the LT header 801) in addition to the expected use times 1005.

The history log sending unit 246 is a unit for sending the history logs recorded in the terminal device 102 to the right management server 101b, and it sets the recorded history logs in the LT 800 and returns them to the right management server 101b in the first embodiment of the present invention. More specifically, the history log sending unit 246 decides whether it returns the LT 800 to the right management server 101b or not by referring to the history log response condition 913 included in the tag block for indicting history log collection 804 of the LT 800.

The content use control unit 243 controls content use securely based on the LT 800. More specifically, the content use control unit 243 judges whether it is possible to use the content based on the use condition included in the LT 800 which is acquired from the right management server 101b by the license acquirement unit 242 when a user requests for using the content. After that, it performs the processing of passing the content key for decrypting the encrypted content to the content use unit 251 on condition that the use condition permits using the content.

For example, the content use control unit 243 judges whether it is possible to use the content by referring to the LT validated period 814 set in the LT header 801 of the LT 800 and the counter for times 822 set in the LT action tag block 802. Also, it performs the processing of judging that it is possible to play back the content on condition that the present time is included in the LT validated period 814 and the value of the counter for times 822 is 1 or more after referring to the present time provided by the secure timer unit which is stored in the terminal device 102 (the timer unit is not shown in FIG. 2).

In order to send and receive the content key securely, an SAC is established between the content use control unit 243 and the content use unit 251, and thus the content key is sent and received securely.

Also, the content use control unit 243 generates the content history logs as the result of content use control. More specifically, the content use control unit 243 generates transaction-level history logs such as content use (for example, playback) times and content use time by a user and performs the processing of passing them to the first history log collection unit 245.

The secure DB 244 is a database unit operable to manage the data securely and stores the LT acquired by the license acquirement unit 242 and the history logs acquired by the first history log collection unit 245. More specifically, the secure DB 244 stores the LT 800 acquired from the right management server 101b shown in FIG. 8 or the LT 800 including history logs and stores the hash value of the LT 800 in the secure DB 244 in a tamper-proof part both at a hard disk level and at software level in order to prevent illicit conducts such as a manipulation and the like.

The first history log collection unit 245 collects history logs mainly from the content use control unit 243. More specifically, the first history log collecting unit 245 receives history logs acquired by the content use control unit 243 or the second history log collection unit 252 and records them in the secure DB 244 or sends them to the history log sending unit 246 as they are.

The history log sending unit 246 sends history logs recorded in the terminal device 102 to the server 101b. More specifically, the history log sending unit 246 searches the secure DB 244 periodically or at arbitrary timing, acquires a history log (an LT 800) that is uploadable by the right management server 101b and sends the LT to the right management server 101b or sends the history log acquired from the first history log collecting unit 245 to the right management server 101b instantaneously.

The content use unit 250 comprises a content use unit 251 and the second history log collection unit 252.

The content use unit 251 decrypts and decodes the content and records detailed history logs.

More specifically, the content use unit 251 acquires an encrypted download content or an encrypted streaming content, decrypts the encrypted content using a content key to be acquired from the content use control unit 243, decodes the content and outputs the content to a monitor that is not shown in FIG. 2 or the like. At the same time, it records detailed content history logs such as user operation descriptions on the content, information on content use time by a user, state of used content and the like. Also, when finishing using a content, it sends an end notification of the content use to the content use control unit 243.

The second history log collection unit 252 collects history logs from the content use unit 251. More specifically, the second history log collection unit 252 receives user's detailed content history logs acquired from the content use unit 251 and sends them to the first history log collection unit 245.

Note that it is usual that components that need to be processed securely above all in the terminal device 102, to put it more specifically, the license acquirement unit 242, the content use control unit 243, the secure DB 244, the first history log collection unit 245, the history log sending unit 246, the content use unit 251, the second history log collection unit 252 are realized in a tamper-proof LSI at a hard disk level or by a tamper-proof program at software level so as to prevent unpermitted use of content by a malicious user.

Also, the component for reading a content in the terminal device 102, which is not shown in FIG. 2 because they are not focused on, can be a receiving unit with an RTP/UDP or the like for receiving a streaming type content from the Internet or the like or a reading unit operable to read a nonstreaming (download) type content such as an HDD or the like or a content in a package medium.

Up to this point, the detailed construction of the terminal device 102 has been explained.

Here, in order to show the LT 800 including history logs to be generated by the content use control unit 243 and the construction of the history logs, detailed explanations are made with reference to FIGS. 11 and 12.

FIG. 11 is a diagram showing an example of the construction of LT 800. It is different from the LT 800 shown in FIG. 8 in that a history log tag block 1105 where history logs recorded by the terminal device 102 is added to the LT 800 shown in FIG. 8 to make the LT 800 shown in FIG. 11. Therefore, explanations on an LT header 1101, an LT action tag block 1102, a content key tag block 1103, a tag block for indicating history log collection 1104 and an LT footer 1106 are omitted here.

The history log tag block 1105 is the one where history logs obtained by the first history log collection unit 245 and the second history log collection unit 252 have been recorded and has a construction shown in FIG. 12. The history log tag block 1105 comprises a history log tag value 1201 of an identifier for identifying the history log tag block 1105, a history log data length 1202 showing the size of the history log data 1203 and a history log data 1203 where actual history log data have been recorded. The history log data 1203 comprises roughly two parts of information as follows: the first part is a user ID 1205 for identifying a user who uses a content and whose content history logs are recorded and a terminal device 102 and a terminal ID 1206; and the second part is the first history log 1210 and the second history log 1220, both of which show user operation descriptions or the like. Here, it is shown that the user who uses the content is “USER-ID=USER-ID-00001” and that the terminal device 102 where the content is used is “TERMINAL-ID-00001”. The first history log 1210 and the second history log 1220 show history logs recorded by the right management unit 240 and by the content use unit 250 respectively. Here, a user action 1211 “Play” and a time 1212 “2002/12/24 10:00:00” are recorded as the first history log 1210, which shows that the playback started at 10:00:00 o'clock Dec. 24, 2002. Also, user's detailed operation descriptions and operation time, for example, “Play :: 2002/12/24 10:00:00” and “Fwd :: 2002/12/24 10:35:23” are recorded in sequence as the second history log 1220.

The first history log 1210 which is a variable length and the data length of the second history log 1220 are not shown in FIG. 12 in the above-mentioned example because they are not focused on in the present invention, but their data lengths can be added to the formats of the history log data 1203 or a code showing the end of data can be assigned to the data.

Up to this point, the detailed constructions of the LT 800 including history logs and the history log tag block 1105 have been explained with reference to FIGS. 11 and 12.

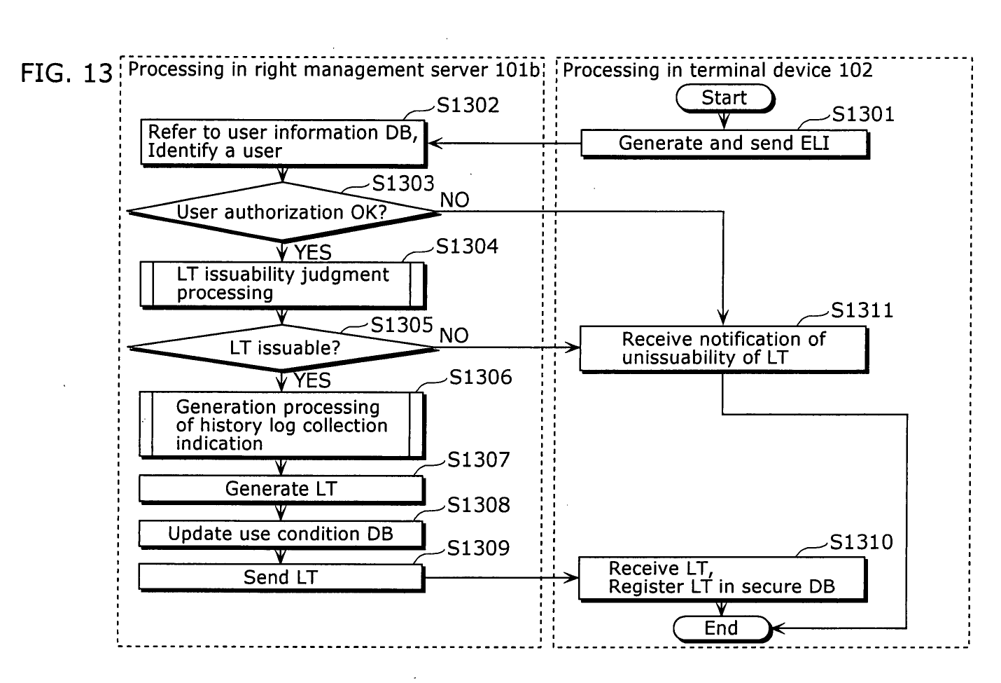

Here, a sequential processing performed in the terminal device 102 constructed in an above-mentioned way will be explained with reference to flow charts shown in FIG. 13 to FIG. 18. The processing is as follows: first, a user acquires an LT 800 from the right management server 101b and uses the content; second, the user records history logs based on the use state; and lastly, the user sends the history logs from the terminal device 102 to the right management server 101b.

When a user tries to acquire an LT 800 from the right management server 101b, the following processing is required in advance: member registration to a service provider using a web server 101d or the like; purchase of a content use condition, content acquirement from a content distribution server 101c and the like, but explanations on the processing is omitted because it is not focused on in the present invention.

First, user operation for acquiring an LT 800 from the right management server 101b in the terminal device 102 will be explained using a flow chart shown in FIG. 13.

When a user acquires a user use condition list managed in the right management server 101b by a user interface provided by a terminal application 280 and selects use condition of the desired content from the user use condition list, the terminal device 102 makes the ELI 1000 for requesting the LT of an applicable use condition to the right management server 101b and sends it to the right management server 101b (step S1301).

More specifically, the content use unit 251 receives, from the terminal application 280, a content ID of the content that satisfies the use condition selected by the user and sends it to the content use control unit 243. The content use control unit 243 sends the content ID to the license acquirement unit 242, and the license acquirement unit 242 generates the ELI 1000 shown in FIG. 10 based on the content ID received from the content use control unit 243. Note that the use condition ID 1003 set in this ELI 1000 is considered to be acquired when the terminal application 280 or the right management unit 240 makes an inquiry on the use condition of a user in advance via the right management server 101b or the web server 101d. Also, the expected use times 1005 can be set at a value desired by a user via the terminal application 280 or at a value predetermined by operating a service in advance. The ELI 1000 generated in this way is sent to the right management server 101b via the second sending and receiving unit 241.

The license issuing unit 212 of the right management server 101b receives the ELI 1000 from the terminal device 102, identifies a user by referring to the user information DB 201 so as to perform user authentication (step S1302).

More specifically, the user authentication is performed in two steps. When exchanging data that requires security like an LT 800, it is usual that an SAC is established so as to communicate securely. Therefore, in the first step, an SAC is established between the right management server 101b and the terminal device 102. When establishing an SAC, a secure socket layer (SSL) or a transport layer security (TLS) can be used. This mutual authentication makes it possible to confirm that the terminal device 102 has a correct terminal ID 1002. In the second step, the license issuing unit 212 identifies a user who owns the terminal device 102 with the terminal ID 1002. The license issuing unit 212 acquires the terminal ID 1002 included in the ELI 1000, refers to the user ID 301 and the terminal ID 302 in the user information management table 300 in the user information DB 201 and searches the terminal ID 302 in the user information management table 300 corresponding to the terminal ID 1002 included in the ELI 1000. When the matching terminal ID 302 is detected, the user ID 301 corresponding to the terminal ID 302 can be acquired but the user authentication fails when no matching terminal ID 302 is detected.

The license issuing unit 212 confirms the user authentication result in the step S1302 (step S1303).

When the answer of the step S1303 is YES, that is, when a user authentication is performed correctly, step S1304 is performed so as to confirm the use condition for issuing an LT 800.

When the answer of the step S1303 is NO, that is, when a user authentication is not performed correctly, it is judged that no LT is issuable and the license issuing unit 212 sends a notification of unissuability of an LT to the terminal device 102.

The license issuing unit 212 executes the LT issuability judgment processing (step S1304). This LT issuability judgment processing will be explained in detail later with reference to a figure.

The license issuing unit 212 refers to the result of the LT issuability judgment processing and judges whether the LT 800 is issuable or not (step S1305).

When the answer of the step S1305 is YES, that is, when it is judged that an LT is issuable, step S1306 is performed.

When the answer of the step S1305 is NO, that is, when it is judged that no LT is issuable, the license issuing unit 212 sends a notification of unissuability of an LT to the terminal device 102.

The license issuing unit 212 requests the history log collection indication unit 211 to generate the indication information 903 for history log collection shown in FIG. 9 and the history log collection indication unit 211 performs the generation processing of history log collection indication (step S1306). This generation processing of history log collection indication will be explained in detail later with reference to a figure.

The license issuing unit 212 receives the indication information 903 for history log collection from the history log collection indication unit 211 and generates the LT 800 (step S1307).

More specifically, the license issuing unit 212 receives the indication information 903 from the history log collection indication unit 211 and generates a tag block for indicating history log collection 804.

Also, it refers to the history log management table 500 of the ELI 1000 and the use condition DB 203, acquires the content key 402 corresponding to the content ID 1004 (content ID 401) from the content key management table 400 of the content key DB 202 and generates an LT 800 including the use condition requested for by the ELI 1000.

The license issuing unit 212 updates the history log management table 500 of the use condition DB 203 (step S1308). More specifically, the license issuing unit 212 performs processing of subtracting a use condition of the user included in the issued LT 800 from a user use condition. For example, when the counter for times 822 of the LT action tag block 802 of the LT 800 is “3” on condition that the available times 505 of the history log management table 500 is “5”, the available times 505 of the history log management table 500 is updated to “2”.

The license issuing unit 212 sends the LT 800 generated in the step S1307 to the terminal device 102 (step S1309). More specifically, the license issuing unit 212 performs the processing of sending the LT 800 to the terminal device 102 via the first sending and receiving unit 214.

The license acquirement unit 242 of the terminal device 102 receives the LT 800 from the right management server 101b and registers the LT 800 in the secure DB 244 (step S1310). More specifically, the license acquirement unit 242 acquires the LT 800 as a response corresponding to the ELI 1000 generated in the step S1301 via the second sending and receiving unit 241, writes the LT 800 in the secure DB 244 and updates the hash value of the secure DB 244.

When a notification of unissuability of LT is sent in the step S1303 or the step S1305 because the LT 800 is unissuable, the license issuing unit 242 of the terminal device 102 receives the notification of unissuability of LT (step S1311). More specifically, the license acquirement unit 242 of the terminal device 102 receives the notification of unissuability of LT from the right management server 101b and notifies the user of the above-mentioned processing via the user interface of the terminal application 280 so as to finish this processing.

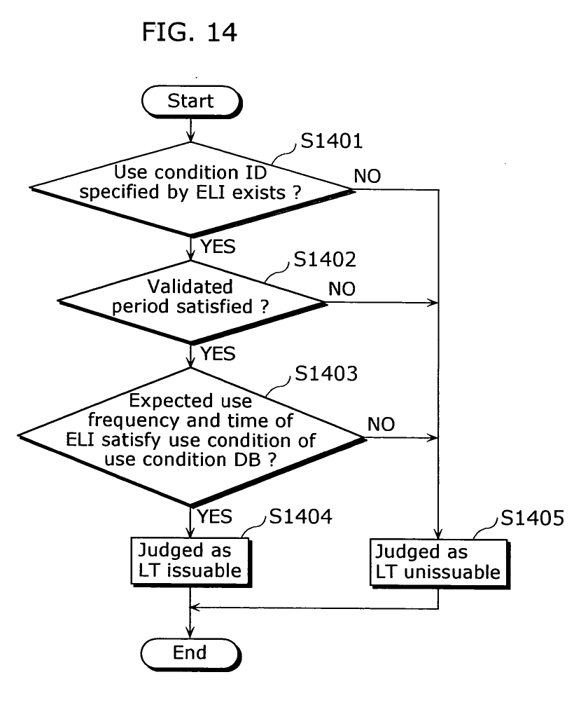

Here, the LT issuability judgment processing of the step S1304 will be explained with reference to FIG. 14.

First, the license issuing unit 212 confirms whether a use condition ID 1003 specified by the ELI 1000 is included in the history log management table 500 of the use condition DB 203 or not (step S1401). More specifically, the license issuing unit 212 refers to the ELI 1000 received from the terminal device 102 and acquires the use condition ID 1003. Also, it confirms whether this use condition ID 103 matches a use condition ID 502 in the use condition management table 500 or not.

When the answer of the step S1401 is YES, that is, when a use condition ID 502 that matches the use condition ID 1003 of the ELI 1000 is included in the use condition management table 500, whether the user ID 501 including the use condition ID 502 matches the user ID 301 in the user information management table 300 in the user information DB 201 of a user authenticated in the step S1302 in FIG. 13 or not is further confirmed. Step S1402 is executed when the user IDs match each other here, but step S1405 is performed when the user IDs do not match each other.

When the answer of the step S1401 is NO, that is, when a use condition ID 502 that matches the use condition ID 1003 of the ELI 1000 is not included in the use condition management table 500, step S1405 is executed.

Next, the license issuing unit 212 judges whether the user use condition satisfies the validated period or not (step S1402). More specifically, the license issuing unit 212 refers to the validated period 504 in the use condition management table 500 of the use condition DB 203, acquires present time from the secure timer unit (not shown in FIG. 2) and judges whether the present time is included in the validated period 504.

For example, when the present time is “2002/12/18 12:34:56” on condition that the validated period 504 in the use condition management table 500 is “2002/12/20 12:12:12”, it is judged that the user use condition is included in the validated period. On the other hand, when the present time is “2002/12/31 19:00:00”, it is judged that the user use condition is not included in the validated period.

When the answer of the step S1402 is YES, that is, when the user use condition is included in the validated period, step S1403 is executed.

When the answer of the step S1402 is NO, that is, when the user use condition is not included in the validated period, step S1405 is executed.

The license issuing unit 212 judges whether the expected use times 1005 of the ELI 1000 satisfies the use condition owned by the user or not (step S1403). More specifically, the license issuing unit 212 confirms whether the expected use times 1005 specified by the ELI 1000 is not more than the times specified as the available times 505 in the use condition management table 500 or not. For example, when the expected use times 1005 specified by the ELI 1000 is “3” on condition that the available times 505 in the use condition management table 500 is “5”, it is judged that the expected use times 1005 specified by the ELI 1000 satisfies the user use condition. On the other hand, when the expected use times 1005 specified by the ELI 1000 is “10”, it is judged that the expected use times 1005 specified by the ELI 1000 does not satisfy the user use condition.

When the answer of the step S1403 is YES, that is, when the expected use times 1005 satisfies the user use condition, step S1404 is executed.

When the answer of the step S1403 is NO, that is, when the expected use times 1005 does not satisfy the user use condition, step S1405 is executed.

The license issuing unit 212 judges the LT 800 as issuable and finishes the LT issuability judgment processing (step S1404).

Also, the answers of the step S1401 to S1403 are NO, that is, when the license issuing unit 212 judges the LT 800 as unissuable, the LT issuability judgment processing finishes (step S1405).

Up to this point, explanation on the LT issuability judgment processing has been finished with reference to FIG. 14.

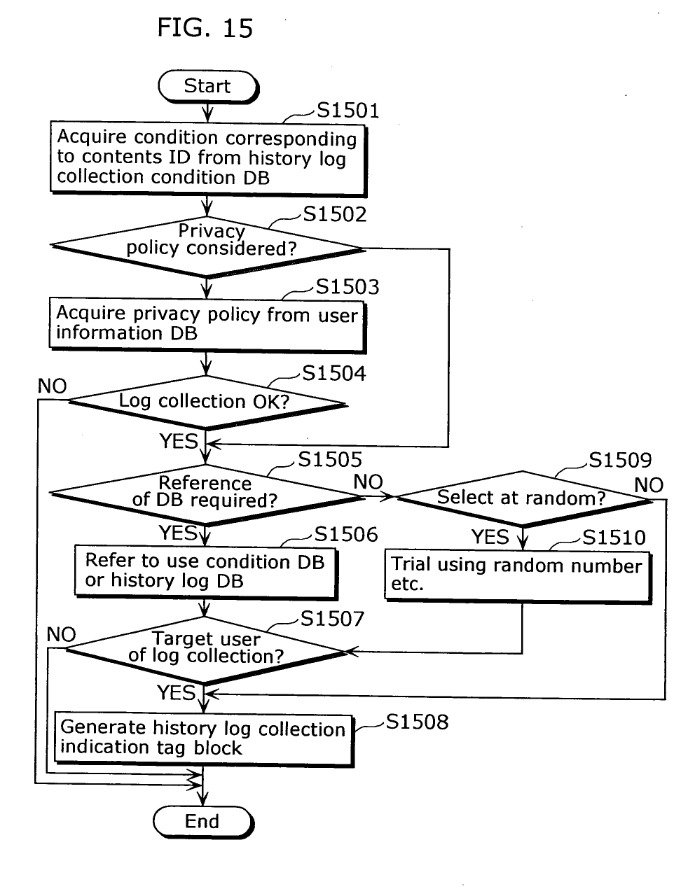

Also, the generation processing of history log collection indication of the step S1306 will be explained with reference to FIG. 15.

The history log collection indication unit 211 acquires, from the history log collection condition DB 204, the history log collection condition 602 corresponding to the content ID 1004 specified by the ELI 1000 (step S1501). More specifically, the history log collection indication unit 211 refers to the history log collection condition management table 600 of the history log collection condition DB 204 and acquires the history log collection condition 602 whose content ID 601 matches the content ID 1004 specified by the ELI 1000.

Next, the history log collection indication unit 211 judges whether the target user determination condition 603 of the history log collection condition 602 acquired in the step S1501 indicates that user's privacy policy needs to be considered or not (step S1502). More specifically, the history log collection indication unit 211 refers to the target user determination condition 603 and judges that the privacy policy set by the user needs to be considered as to the history log collection on the content. For example, the content whose content ID 601 is “CONTENT-ID-00003” is an example in the case where the setting of the target user determination condition 603 in FIG. 6 indicates that privacy policy needs to be considered.

When the answer of the step S1502 is YES, that is, when user's privacy policy needs to be considered, step S1503 is executed.

When the answer of the step S1502 is NO, that is, when user's privacy policy does not need to be considered, step S1505 is executed.

The history log collection indication unit 211 acquires user's privacy policy by referring to the user information DB 201 (step S1503). More specifically, the history log collection indication unit 211 acquires the privacy policy 304 of the user information management table 300 of the user information DB 201.

The history log collection indication unit 211 refers to the privacy policy 304 acquired in the step S1503 and judges whether the user permits the service provider to collect his or her history logs or not (step S1504). More specifically, the history log collection indication unit 211 judges that collecting history logs is permitted on condition that the privacy policy 304 is “History log collecting OK” or “Detailed history log collecting OK”. On the other hand, when the privacy policy 304 is “History log collecting NG”, it judges that collecting history logs is not permitted.

When the answer of the step S1504 is NO, that is, in the case of “History log collecting NG”, no history log collection indication information needs to be generated and thus this generation processing of history log collection indication finishes.

When the answer of the step S1504 is YES, that is, in the case of “History log collecting OK”, step S1505 is executed. In other words, the history log collection indication unit 211 further judges whether various database units of the right management servers 101b need to be referred to or not (step S1505) because it determines a user whose history logs to be collected. More specifically, the history log collection indication unit 211 refers to the target user determination condition 603 acquired in the step S1501 and judges whether the use condition DB 203, the history log DB 205 and the like need to be referred to or not. For example, as the target user determination condition 603 of the content whose content ID 601 is “CONTENT-ID-00002” in FIG. 6, users who have 5 or more history logs in his/her history log DB 205 are determined as target users whose history logs are collected and thus the history log DB 205 needs to be referred to. Also, as the target user determination condition 603 of the content whose content ID 601 is “CONTENT-ID-00004” is “10 or more user records”, users who have “10 or more user records” in his or her use condition DB 203 are determined as target users whose history logs are collected, and thus accesses to the use condition DB 203 occur.

When the answer of the step S1505 is YES, that is, when access to the database unit is generated so as to determine the target user of history log collection, step S1506 is executed.

When the answer of the step S1505 is NO, that is, when access to the database unit is not needed so as to determine the target user of history log collection, step S1509 is executed.

The history log collection indication unit 211 refers to the database unit corresponding to the condition written in a target user determination condition 603 and acquires data on the user (step S1506).

The history log collection indication unit 211 judges whether the user should be chosen as the target user of the history log collection or not based on the information acquired from its database unit (step S1507). More specifically, the history log collection indication unit 211 refers to the user data acquired in the step S1506 and judges whether the acquired data satisfies the target user determination condition 603 or not. For example, in the case of the content whose content ID 601 is “CONTENT-ID-00002” in FIG. 6, the user is determined as the target user whose history logs are collected if the number of the user history logs acquired in the step S1506 is 10. On the other hand, if the number of the user history logs acquired in the step S1506 is 3, the user is not determined as the target user whose history logs are collected because the number of his or her history logs does not satisfy the target user determination condition 603 in the history log collection condition management table 600.

The history log collection indication unit 211 generates a tag block for indicating history log collection 804 (step 51508). More specifically, the history log collection indication unit 211 performs the processing for generating the tag block for indicating history log collection 804 shown in FIG. 9 based on the history log collection condition management table 600.

Also, when the answer of the step S1505 is NO, the history log collection indication unit 211 judges whether target users should be chosen at random or not by referring to the target user determination condition 603 (step S1509).

When the answer of the step S1509 is YES, that is, when choosing target users whose history logs are collected at random, step S1510 is executed.

When the answer of the step S1509 is NO, that is, when it is judged that history logs are collected from all the users, step S1508 is executed so as to generate tag blocks for indicating history log collection 804.

In the step S1510, the history log collection indication unit 211 generates data for choosing target users of the history log collection by performing a trial using random numbers or the like and executes step S1507.

As the generation processing of history log collection indication in the step S1306 has been explained up to this point, explanation on the operation by the terminal device 102 for acquiring an LT 800 from the right management server 101b finishes.

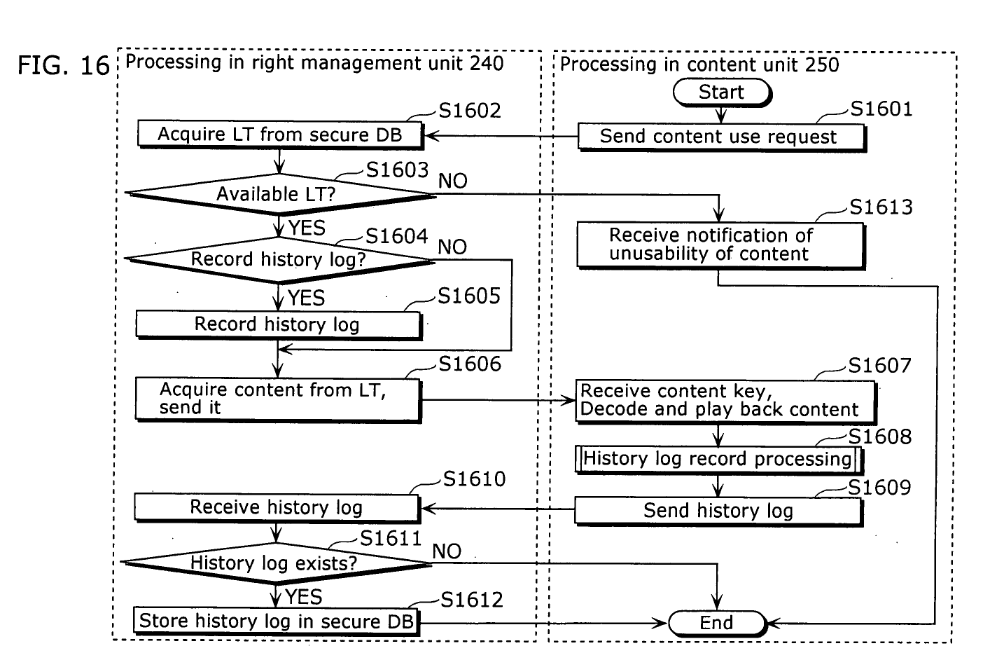

Next, the operation for recording history logs needed when a user uses the content in the terminal device 102 will be explained using the flow chart shown as FIG. 16.

When a user selects content to be used from a list of content stored in the content storage unit which is not shown in FIG. 2 or from a list of streaming contents on the web display screen to be provided by a web server 101d or the like via a user interface provided by the terminal application 280, the content use unit 250 in the terminal 102 sends the content ID of the content received from the terminal application 280 to the right management unit 240 (step S1601). More specifically, the content use unit 251 of the content use unit 250 receives, from the terminal application 280, a unified resource identifier (URI) showing the content ID selected by a user and the location of the content, sends the content ID to the content use control unit 243 in the right management unit 240 and requests for using the content. Note that using content means playing back the content in the first embodiment of the present invention.

The content use control unit 243 acquires the LT 800 corresponding to the content ID from the secure DB 244 (step S1602). More specifically, the content use control unit 243 searches the secure DB 244 making the content ID received from the content use unit 251 as the key.

The content use control unit 243 acquires the LT 800 searched in the step S1602 and judges whether available LT 800 is included or not. More specifically, the content use control unit 243 confirms whether an LT 800 corresponding to the content ID specified by the content use unit 251 is included in the secure DB 244. When the matching LT 800 is included, it refers to the LT validated period 814 and the counter for times 822 of the LT 800 and confirms the validity of the LT 800. As to confirming the validity of the LT validated period 814, it is checked using the time information acquired from a secure timer unit (not shown in FIG. 2) in the terminal device 102. Also, it is confirmed that the value of the counter for times 822 is “1”. When no LT 800 corresponding to the content ID specified from the content use unit 251 is included in the secure DB 244, step S1613 is executed.

When the answer of the step S1603 is YES, that is, when it is judged that the LT 800 is available, step S1604 is executed.

When the answer of the step S1603 is NO, that is, when it is judged that the LT 800 is not available, step S1613 is executed.

The content use control unit 243 judges whether history logs should be recorded or not when using the content (step S1604). More specifically, the content use control unit 243 detects presence/absence of the tag block for indicating history log collection 804 of the LT 800 acquired from the secure DB 244 and decides whether the processing for recording the history logs is executed or not. It is possible to decide whether the history logs should be recorded or not by referring to the descriptions of the tag block for indicating history log collection 804 or the information on the other history log collection indications which can be understood by the content use control unit 243 instead of deciding using the method for deciding whether the history logs should be recorded or not based on the presence/absence of the tag block for indicating history log collection 804 of the LT 800.

When the answer of the step S1604 is YES, that is, when it is judged that history logs should be recorded, step S1605 is executed.

When the answer of the step S1604 is NO, that is, when it is judged that history logs need not be recorded, step S1606 is executed.

The content use control unit 243 records the history logs (step S1605). More specifically, the content use control unit 243 refers to the first history log collection indication information 910 in the indication information 903 of the tag block for indicating history log collection 804 and records the history logs according to the indication descriptions. For example, as shown in FIG. 9, when “action” and “time” are included in the first history log collection indication information 910 as the first history log description 912, it records the date and time information acquired from the secure timer unit (not shown in FIG. 2) and “Play” as an action specified by the user. When no first history log collection indication information 910 is included in the indication information 903, the content use control unit 243 does not record history logs. The history logs recorded in this way are sent to the first history use collection unit 245.

The content use control unit 243 acquires a content key and sends it to the content use unit 251 (step S1606). More specifically, the content use control unit 243 acquires the content key from the content key tag block 803 of the LT 800 and sends it to the content use unit 251 via an SAC. At the same time as sending the content key, the content use control unit 243 sends the second history log collection indication information 920 in the indication information 903 included in the tag block for indicating history log collection 804 of the LT 800 and indicates collecting the history logs in the content use unit 251.

The content use unit 251 acquires the content key, decrypts the encrypted content and plays back the content (step S1607). More specifically, the content use unit 251 receives the content key from the content use control unit 243 and acquires the encrypted content using a URI of the content acquired from the terminal application 280. It decrypts the encrypted content using the content key, decodes the content and outputs the content on the monitor or the like which is not shown in FIG. 2.

The content use unit 251 executes history log record processing so as to record the detailed history logs (step S1608). This history log record processing will be explained in detail later with reference to a figure.

The second history log collection unit 252 sends the history logs acquired from the content use unit 251 to the first history log collection unit 245 (step S1609).

The first history log collection unit 245 receives history logs from the second history log collection unit 252 (step S1610).

The first history log collection unit 245 judges whether there exists any valid history log which was recorded in the content use control unit 243 and the content use unit 251 (step S1611). More specifically, it is a necessary processing for judging whether history logs should be stored in the secure DB 244 in the steps S1604 and the step S1608 because history logs may not be recorded depending on the descriptions of the indication information 903 of the tag block for indicating history log collection 804 or presence/absence of the indication information 903.

When the answer of the step S1611 is YES, that is, when a valid history log is recorded, step S1612 is executed.

When the answer of the step S1611 is NO, that is, when no valid history log is recorded, this processing finishes.

The first history log collection unit 245 stores history logs in the secure DB 244 (step S1612). More specifically, the first history log collection unit 245 inserts a history log tag block 1105, in which a history log data 1203 is set, for writing history logs into the LT 800 as shown in FIGS. 11 and 12. LT 800 shown in FIG. 11 is written in the secure DB 244 and the secure DB 244 is updated.

When no available LT 800 is included in the step S1603, the content use unit 251 receives a notification of unusability from the content use control unit 243 (step S1613). The content use unit 251 notifies the user of the above-mentioned processing via the user interface to be provided by the terminal application 280.

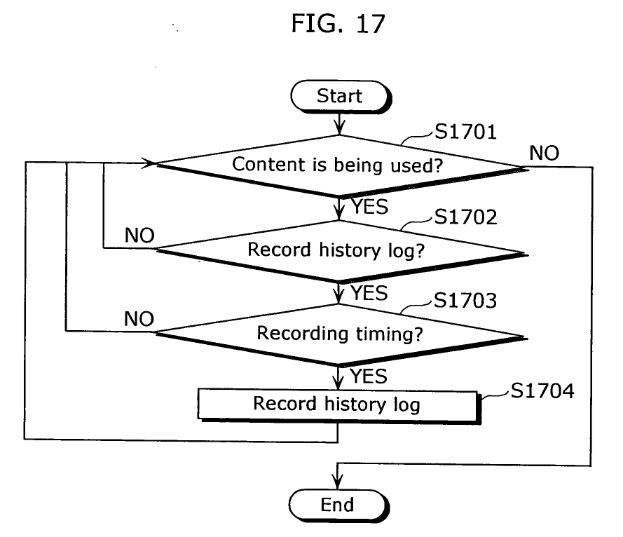

Here, history log record processing in the step S1608 will be explained with reference to FIG. 17.

The content use unit 251 monitors whether the content is being used or not after starting the content use processing (step S1701).

When the answer of the step S1701 is YES, that is, when the content is being used, step S1702 is executed.

When the answer of the step S1701 is NO, that is, when the content use unit 251 receives an end notification of the content use from the user via the terminal application 280 or when it plays back a content until it finishes, it recognizes the end of the content use and finishes the processing.

The content use unit 251 judges whether history logs need to be recorded or not (step S1702). More specifically, the content use unit 251 judges whether the history logs need to be recorded or not by confirming the presence/absence of the second history log collection indication information 920 received from the content use control unit 243.

When the answer of the step S1702 is YES, that is, when history logs need to be recorded, step S1703 is executed.

When the answer of the step S1702 is NO, that is, when history logs need not to be recorded, step S1701 is executed (which means that no history log is recorded).

The content use unit 251 refers to the descriptions of the second history log collection indication information 920 and judges whether present time is the timing for recording history logs or not (step S1703). More specifically, the content use unit 251 judges whether it is indicated at this present time that the history logs should be recorded based on the second history log record condition 921 of the second history log collection indication information 920. For example, when the second history log record condition 921 is “for each user”, the content use unit 251 makes a judgment of executing the processing for recording history logs on condition that the user operation has occurred before executing this step or not executing the processing for recording history logs on condition that no the user operation has occurred yet before executing performing this step. Also, if the second history log record condition 921 indicates that “history logs for each 10 seconds” should be recorded, it becomes possible to judge whether history logs should be recorded or not by notifying the content use unit 251 of the timing for recording history logs in this step using any timer unit and counts time at an interval of 10 seconds.

When the answer of the step S1703 is YES, that is, when it is judged that it is the timing for recording history logs, step S1704 is executed.

When the answer of the step S1703 is NO, that is, when it is judged that it is not the timing for recording the history log, step S1701 is executed.

The content use unit 251 records history logs and sends the recorded history logs to the second history log collection unit 252 (step S1704). After that step S1701 is executed.

When an end notification of content use from the content use unit 251 or another notification is issued in the step S1610 in FIG. 16, it is also possible to record history logs in the content use control unit 243 and send the history logs to the first history log collection unit 245. For example, it is possible to acquire history log (which can include time information) on the “end of content use” at this timing.

Up to this point, the operation for recording history logs using the content in the terminal device 102 has been explained.

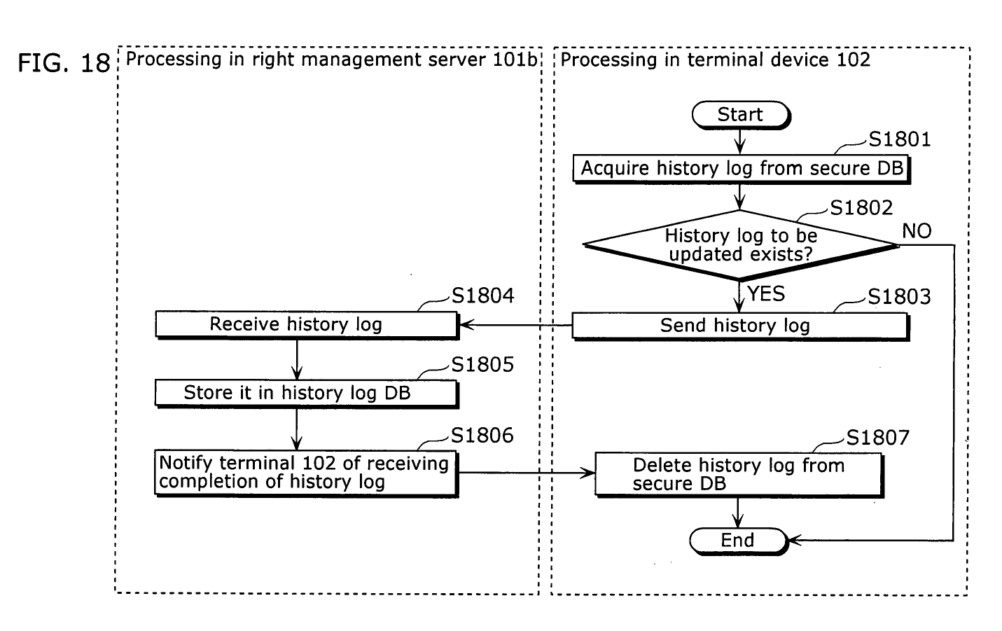

Lastly, the operation for sending history logs recorded the terminal device 102 to the right management server 101b will be explained with reference to the flow chart shown in FIG. 18.

The history log sending unit 246 of the terminal device 102 acquires history logs (LT 800) should be sent to the right management server 101b from the secure DB 244 (step S1801). More specifically, the history log sending unit 246 searches all the LTs 800 in the secure DB 244 and refers to the history log response condition 913 in the indication information 903 of the tag block for indicating the history log collection indication 804. Here, when the history log satisfies the response condition, the LT 800 is acquired from the secure DB 244 as the history log (LT 800) to be sent to the right management server 101b.

The history log sending unit 246 confirms the presence/absence of the LT 800 to be sent to the right management server 101b as a result obtained in the step S1801 (step S1802).

When the answer of the step S1802 is YES, that is, when an LT 800 to be sent to the right management server 101b is included, step S1803 is executed.

When the answer of the step S1802 is NO, that is, when no LT 800 to be sent to the right management server 101b is included, this processing finishes.

The history log sending unit 246 sends history logs to the right management server 101b (step S1803). More specifically, the history log sending unit 246 sends the LT 800 including history logs to the right management server 101b via the second sending and receiving unit 241.

The history log receiving unit 213 in the right management server 101b receives history logs from the terminal device 102 (step S1804). More specifically, the history log receiving unit 213 receives the LT 800 as history logs from the terminal device 102 via the first sending and receiving unit 214.

The history log receiving unit 213 stores history logs in the history log DB 205 (step S1805). More specifically, it writes the data of the history log tag block 1105 included in the LT 800 received from the terminal device 102 on the history log management table 700 so as to update the data.

The history log receiving unit 213 sends an end notification of receiving a history log to the terminal device 102 (step S1806).

The history log sending unit 246 in the terminal device 102 completely deletes the LT 800 sent to the right management server 101b (step S1807) by updating (committing) the sent secure DB 244 at the time of receiving an end notification of receiving a history log from the right management server 101b.

Up to this point, the operation of the terminal device 102 for sending history logs to the right management server 101b has been explained.

An example case where absolute time information showing the time when a user used the content is recorded as a history log to be recorded in the terminal device 102 in the first embodiment of the present invention, but relative time information showing the elapsed time needed to read out the content starting from its head to the present location, information showing special part of the content such as chapter number using a metadata and the like, data amount from its head to the present location, information showing sub contents that construct the content and the like can also be recorded.

Also, when recording user operations as history logs to be recorded in the terminal device 102, not only content playback, special playback such as forwarding, copying them to a storage medium but also storing them to an HDD, exchanging them between terminal devices, LT backup from a storage medium or LT restoring to the storage medium may be recorded as the history logs.

Also, when recording a user's content use state as history logs to be recorded in the terminal device 102, classification such as real time viewing, automatic recording, reservation recording, manual recording, copying and the like may be recorded. In this case, the content use unit 250 for recording or the content use unit 250 for copying which correspond to the content use unit 250 in FIG. 2. is needed. Further, it is possible to record history logs securely by acquiring an LT when recording or copying.

Also, it is conceivable that a way of providing the content is recorded as a history log to be recorded in the terminal device 102. For example, it is possible to record information obtained by judging whether the content to be used is a on demand program or not or whether the content to be used is the content in a package medium or not or another information.

Also, the status of the terminal device 102 may be recorded as history logs to be recorded in the terminal device 102. For example, the right management unit 240 and the content use unit 250 in the terminal device 102 performs mutual authentication when establishing an SAC, and information on an authentication error that occurred at that time and information on revocation may be recorded as history logs.

Also, a way of providing service may be recorded as history logs to be recorded in the terminal device 102. For example, it is information obtained by judging whether the content to be used is a on demand program or not or whether the content to be used is the content in a package medium or not.

Also, example cases of “History log collecting NG”, “History log colleting OK only in the content use control unit 243” or “Detailed history log collecting OK in the content use control unit 243 and the content use unit 251” based on the respective privacy policies preset by the respective users are shown in the first embodiment of the present invention, privacy policy is not limited to the ones mentioned above, in other words, various privacy policies may be preset. Conceivable cases are, for example, a case where a user permits a service provider to collect history logs concerning content playback in the terminal device 102 but the user does not permit the provider to collect history logs generated when reading history logs from a terminal device 102 and writing them to a storage medium is not permitted, a case where “History log collecting OK” or “History log collecting NG” is preset depending on the type or the genre of the content or other cases.

Also, it is possible to judge whether history log collection should be performed or not based on the privacy policy preset by the user in the terminal device 102 when recording history logs in the terminal device 102. More specifically, it is possible to collect history logs according to the privacy policy by referring to the privacy policy stored in the terminal device 102 in the step S1702 in the flow chart shown in FIG. 17. Various kinds of conditions can be set as a security policy in this case, for example, the case where “History log collecting OK” or “History log collecting NG” is preset based on the user operation description, the content type, the genre or the like.

Also, it is possible to display a notification on history log collection or a message for asking a user whether he or she permits the service provider to collect his or her history logs in the terminal application 280 in the terminal device 102.

Also, it is possible to include information showing that a user permits or forbids the right management server 101b to collect his or her history logs in the ELI 1000 sent from the terminal device 102 to the right management server 101b when requesting an LT 800. In this case, either information included in the ELI 1000 or privacy policy 304 in the user information management table 300 may be given a priority as to all or specific contents.

Further, an example case where history log record timings specified by the right management server 101b to the terminal device 102 are determined for each content or for each user operation in the first embodiment of the present invention, but they can be determined by the time or for each component of a program or a content.

As mentioned above, detailed user history logs can be collected in the first history log collecting unit 245 and the second history log collecting unit 252 of the terminal device 102 based on the indication information from the right management server 101b in the content history log collecting system 1. Also, it is possible to flexibly specify the timing for recording history logs by the right management server 101b or the timing for uploading history logs to the right management server 101b using the indication information for history log collection. Therefore, it becomes possible to collect history logs flexibly according to the needs of service providers or various service types.

(Second Embodiment)

The second embodiment of the present invention will be explained below with reference to figures.

Explanation on the content history log collecting system 2 to be explained in the second embodiment of the present invention will be made with reference to FIG. 1 because it has the same outline construction as the content history log collecting system 1 shown in FIG. 1.

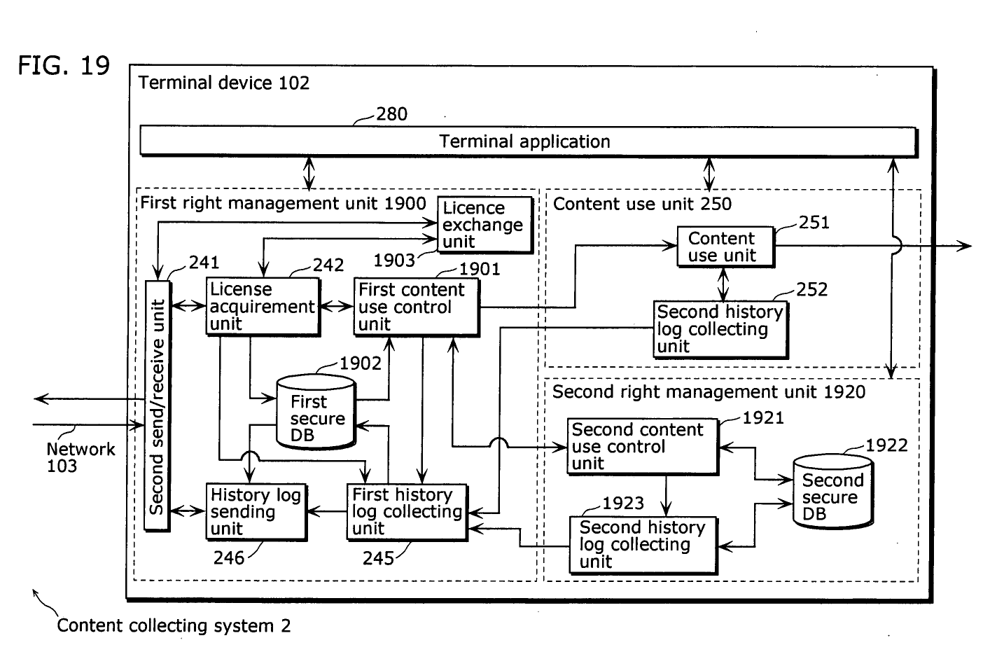

Also, as the construction of the distribution center 101 in the content history log collecting system 2 is the same as the construction of the distribution center 101 in the content history log collecting system 1 in the following FIG. 19, the construction of the right management server 101b will be explained with reference to FIG. 2.

FIG. 19 is a block diagram showing the construction of the terminal device 102 concerning the second embodiment of the present invention. As the same components in this figure as the terminal device 102 concerning the first embodiment shown in FIG. 2 have already been explained in FIG. 2, explanations on these components are omitted although the same reference numbers are assigned to them.

The terminal device 102 shown in FIG. 19 comprises the first right management unit 1900 instead of the right management unit 240 in FIG. 2, the second right management unit 1920 and the content use unit 250.

The first right management unit 1900 includes the second sending and receiving unit 241, a license acquirement unit 242, the first history log collecting unit 245, a history log sending unit 246, the first content use control unit 1901, the first secure DB 1902 and a license exchange unit 1903.

Also, the second right management unit 1920 includes the second content use control unit 1921, the second secure DB 1922 and the third history log collecting unit 1923.

As the first content use control unit 1901 has the same function as the content use control unit 243 in FIG. 2 and the first secure DB 1902 and the second secure DB 1922 have the same function as the secure DB 244 in FIG. 2, explanations on them will be omitted here.

The license exchange unit 1903 exchanges an LT 800 with another terminal device 102 via the network 103. More specifically, the license exchange unit 1903 communicates with the license exchange unit 1903 of another terminal device 102 connected with a home network via the second sending and receiving unit 241, acquires the LT 800 from another terminal device 102 or provides another terminal device 102 with an LT 800.

The second content use control unit 1921 basically has a function equivalent to the first content use control unit 1901 in the first right management unit 1900 and performs content use control securely according- to the LT 800. Note that the second content use control unit 1921 is a unit for processing an LT 800 unprocessable by the first content use control unit 1901, and thus, when the terminal application 280 makes a content use request, it processes the LT 800 and performs the processing for providing the content use unit 250 with a content key.

The second secure DB 1922 has a function equivalent to the first secure DB 1902 in the first right management unit 1900 and stores an LT 800 or the LT 800 that includes history logs. As it is possible not to be dependent on the capacity of the first secure DB 1902 by having the second secure DB 1922, there is a merit of flexible processing even when the data amount of history logs to be recorded increases.

The third history log collecting unit 1923 receives history logs to be recorded by the second content use control unit 1921, stores them in the second secure DB 1922 or sends them to the first history log collecting unit 245.

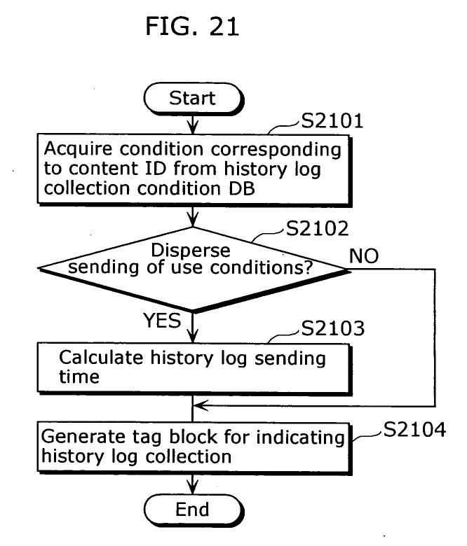

Here, a sequential processing performed in the terminal device 102 constructed as mentioned above will be explained with reference to FIG. 21 to FIG. 24. The processing is as follows: first, a user acquires an LT 800 from the right management server 101b and use the content; second, the user records his or her content history logs according to the use status; lastly, the user sends the history logs from the terminal device 102 to the right management server 10b.

First, the user operation for acquiring an LT 800 from the right management server 101b in the terminal device 102 will be explained using a flow chart shown in FIG. 21. As the processing flow of acquiring the LT 800 by sending an ELI 1000 from the terminal device 102 to the right management server 101b is the same as the processing flow shown in FIG. 13 in the first embodiment of the present invention, only the generation processing for indicating history log collection shown in FIG. 15 will be explained with reference to FIG. 21.

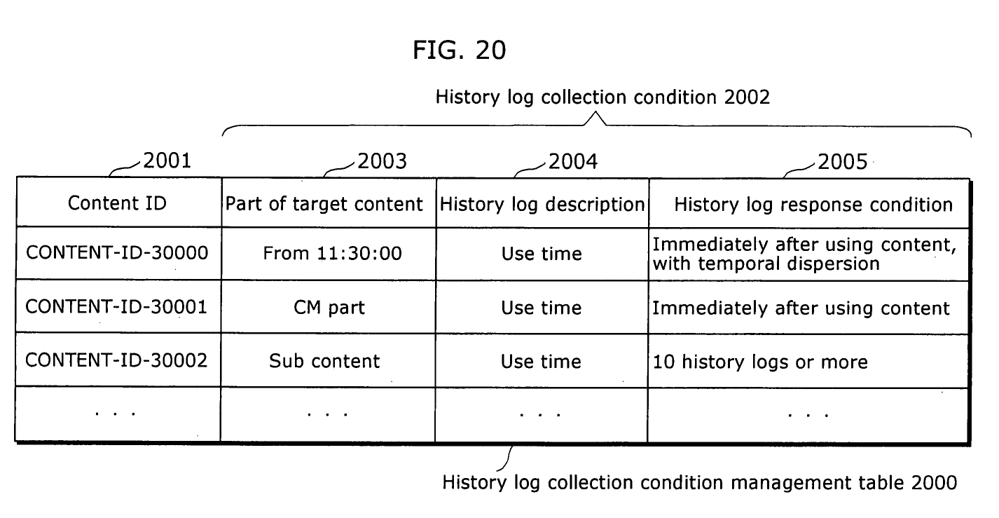

The history log collection indication unit 211 acquires a history log collection condition 602 corresponding to the content ID 1004 specified by the ELI 1000 and the like from the history log collection condition DB 204 (step S2101). More specifically, the history log collection indication unit 211 refers to the history log collection condition management table 2000 shown in FIG. 20 which is a table in the history log collection condition DB 204.

The history log collection condition 2002 in FIG. 20 includes a part of target content 2003 for specifying a part for collecting history logs in the content ID 2001, a history log description 2004 as history log descriptions to be collected, a history log response condition 2005 as the history log response condition.

Here, to be more specific, the part of target content 2003 can be used for recording history logs concerning the use of the special part in the content. For example, the content whose content ID 2001 is “CONTENT-ID-30000” is a program to be broadcast from 11:00 to 12:00 and the climax of the program starts at 11:30:00, when recording the use time on condition that the program is used after 11:30:00, it is possible to acquire the history logs of users who viewed the program after the climax. Also, the content “CONTENT-ID-30001” is the content in which CMs and metadata for specifying the locations of these CMs are included and shows that the use time is to be recorded at the timing when a user viewed a CM. Further, in the case of the content “CONTENT-ID-30002” which is a program including sub contents such as subvoice or the like, use time as a history log is recorded when a user used the sub contents.

Note that the terminal device 102 presets the timing for acquiring history logs as “for each user operation” as a default. For example, in the case of the content whose content ID 2001 is “CONTENT-ID-30000”, its history logs are recorded for each user operation after 11:30:00, and in the case of the content whose content ID is “CONTENT-ID-30001”, its history logs are recorded for each user operation concerning the CM part. Also, the history log response condition 2005 shows the condition to be used by the history log sending unit 246.

The history log collection indication unit 211 refers to this history log collection condition management table 2000 and acquires the history log collection condition 2002 whose content ID 2001 matches the content ID 1004 specified by the ELI 1000.

The history log collection indication unit 211 refers to the history log response condition 2005 of the history log collection condition 2002 acquired in the step S2101 (step S2102). More specifically, the history log collection indication unit 211 refers to the history log response condition 2005 and asks the terminal device 102 if the timings for sending history logs need to be dispersed for each terminal device 102. For example, as “Immediately after using a content, with temporal dispersion” is specified as the history log response condition of the content whose content ID is “CONTENT-ID-30000”, it is specified that history logs are sent to the terminal device 102 immediately after the content is used on condition that the timings for sending history logs are dispersed so as to prevent a deluge of accesses for sending history logs to the right management server 101b.

When the answer of the step S2102 is YES, that is, when the timings for sending history logs need to be dispersed for each terminal device 102, the step S2103 is executed.

When the answer of the step S2102 is NO, that is, when the timings for sending history logs do not need to be dispersed for each terminal device 102 (for example, in the case of the content whose content ID is “CONTENT-ID-30001”), the step S2104 is executed.

The history log collection indication unit 211 calculates the interval for dispersing the timings for sending history logs for each terminal device 102 and determines the sending time of the history logs (step S2103). As to the method for dispersing history log sending time for each terminal device 102, for example, if the content “CONTENT-ID-30000” is a broadband casting program, it is possible to disperse the history log sending time of each terminal device 102 into 256 ways by adding the value of the lower 1 byte of the terminal ID 1002 included in the ELI 1000 at the time when the program of content “CONTENT-ID-30000” finishes.

The history log collection indication unit 211 generates a tag block for indicating history log collection 804 (step S2104). More specifically, the history log collection indication unit 211 performs the processing for generating the tag block for indicating history log collection 804 based on the history log collection condition management table 2000.

Up to this point, the operation for acquiring an LT 800 from the terminal device 102 to the right management server 101b has been explained.

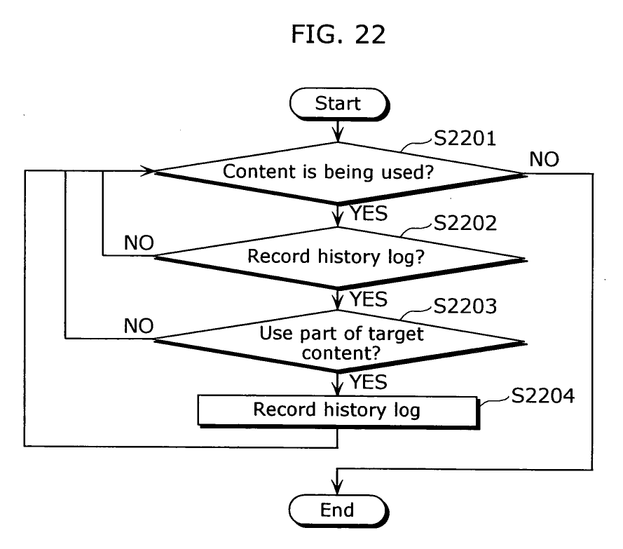

Next, the user operation for using a content and recording history logs in the terminal device 102 will be explained with reference to the flow chart shown in FIG. 22. Note that only the history log record processing shown in FIG. 17 will be explained here with reference to FIG. 22 because the processing flow for recording history logs using a content in the terminal device 102 is the same as the processing flow shown in FIG. 16 in the first embodiment of the present invention.

The content use unit 251 monitors whether the content is being used or not after starting the content use processing (step S2201).

When the answer of the step S2201 is YES, that is, when the content is being used, step S2202 is executed.

When the answer of the step S2201 is NO, that is, when the right management server 101b receives an end notification of the content use from a user via the terminal application 280 or when a user plays back the content up to its end, it recognizes the end of content use and finishes this processing.

The content use unit 251 judges whether history logs need to be recorded or not (step S2202). More specifically, the content use unit 251 judges whether history logs need to be recorded or not by checking the presence/absence of the second history log collection indication information 920 received from the first content use control unit 1901.

When the answer of the step S2202 is YES, that is, when history logs need to be recorded, the step S2203 is executed.

When the answer of the step S2202 is NO, that is, when history logs do not need to be recorded, the step S2201 is executed (therefore, no history log is recorded).

The content use unit 251 refers to the descriptions of the second history log collection indication information 920 and judges whether a user viewed the content part to be a target of history use collection (step S2203). For example, on condition that relative time from the starting time of the program is specified as the second history log collection indication information 920, when it is specified that history logs are acquired when a user views the content after the specified time, it judges whether the history log should be recorded or not by comparing the elapse time from the starting time of the program to the time when performing this step with the relative time specified in the second history log collection indication information 920. Also, when it is indicated that history logs of the content part such as “CM part” or “sub contents” should be recorded as the second history log collection indication information 920, it becomes possible to recognize that a special part of the content is used and judge whether history logs should be recorded or not by recognizing CM parts or sub contents using metadata or the like.

When the answer of the step S2203 is YES, that is, when it is judged that a user used the target content part, step S2204 is executed.

When the answer of the step S2203 is NO, that is, when it is judged that a user did not use the target content part, step S2201 is executed.

The content use unit 251 records history logs and sends the recorded history logs to the second history log collection unit 252 (step S2204). After that, the step S2201 is executed.

Up to this point, the operation for recording history logs using a content in the terminal device 102 has been explained.

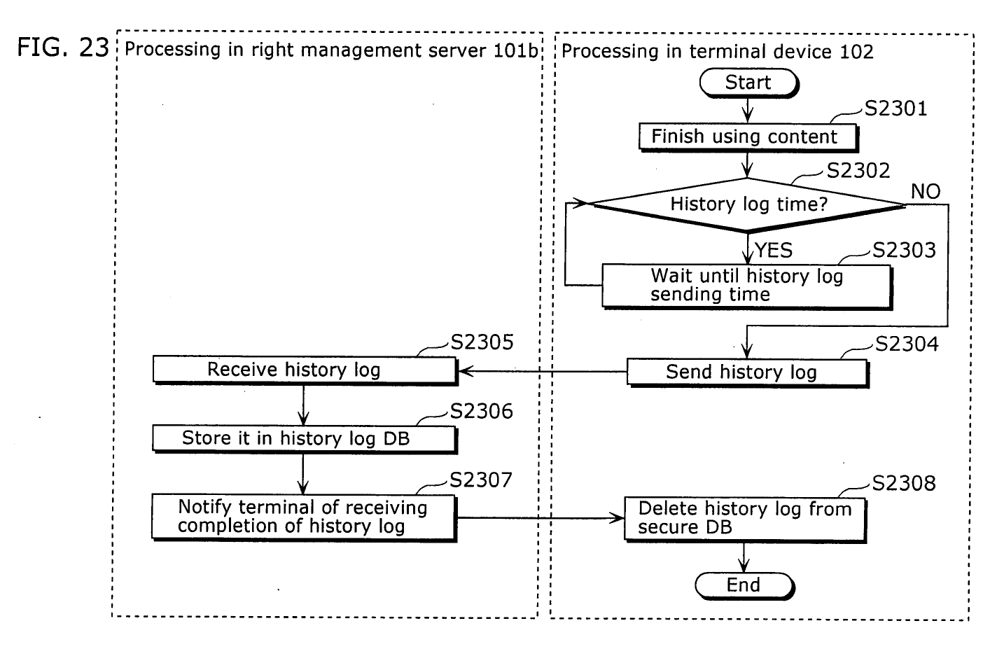

Lastly, the operation for sending the history logs recorded in the terminal device 102 to the right management server 101b will be explained with reference to the flow chart shown in FIG. 23. Here, an example case where history logs are sent immediately after the end of the content use.

The history log collection sending unit 246 of the terminal device 102 refers to a tag block for indicating history log collection 1104 of the LT 800 on receiving history logs from the content use unit 250 and checks the history log response condition 913 (step S2301). More specifically, the history log sending unit 246 acquires an LT 800 including history logs recorded in the secure DB 244 in the step S1612 in FIG. 16 from the secure DB 244.

The history log sending unit 246 checks whether it is the time for sending history logs to the right management server 101b or not (step S2302).

When the answer of the step S2302 is YES, that is, when it is the time for sending history logs to the right management server 101b, step S2304 is executed.

When the answer of the step S2302 is NO, that is, when it is not the time for sending history logs to the right management server 101b, the step S2303 is performed.

The history log sending unit 246 temporally stops the processing until it gets the time for sending history logs (step S2303). More specifically, it is conceivable that the history log sending unit 246 can employ the following methods: a method for executing step S2302 in a polling way by resuming the processing periodically; and a method for stopping the processing temporally until it gets the time for sending history logs by using any timer unit.

The history log sending unit 246 sends history logs to the right management server 101b (step S2304). More specifically, the history log sending unit 246 sends an LT 800 including history logs to the right management server 101b via the second sending and receiving unit 241.

Explanations on the following processing will be omitted because steps S2305 to S2308 are the same processing as the steps S1804 to S1807 in FIG. 18.

Up to this point, the sending operation of history logs to the right management server 101b by the terminal device 102 has been explained.

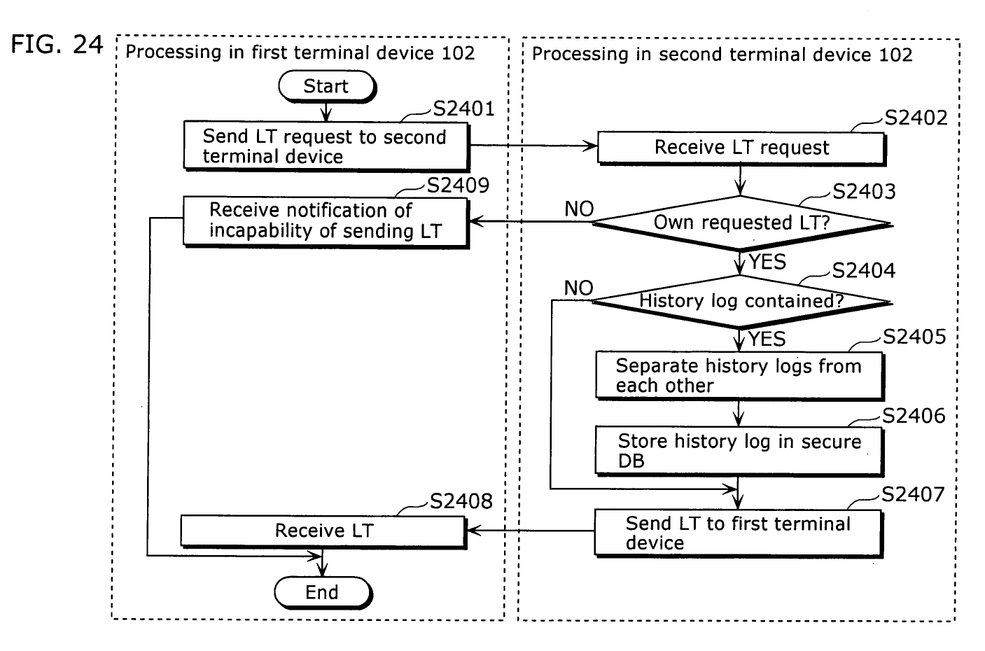

As the first right management unit 1900 of the terminal device 102 has a license exchange unit 1903, it is possible to transfer the LT 800 with another terminal device 102 and thus the history log (history log of LT exchange) at that time is recorded. The processing for this LT exchange will be explained with reference to FIG. 24.

First, a user searches the LT 800 to be acquired in another terminal device 102 (which is written as the second terminal device 102) on the network 103 by the user interface to be provided by the terminal application 280 of the terminal device 102 (which is written as the first terminal device 102) and sends the LT acquirement request to the above-mentioned terminal device 102 (step S2401). More specifically, the license exchange unit 1903 of the first terminal device 102 searches another terminal device 102 capable of communication via the network 103 and acquires a list of LT 800 (an LT list) owned by another terminal device 102. This LT list includes a terminal ID of the terminal that owns an LT 800 and an LT ID capable of identifying the LT 800 in the terminal (in other words, in the content use control system). The license exchange unit 1903 presents the acquired LT list to the user via the terminal application 280. As the license exchange unit 1903 receives a request for acquiring the LT 800 desired by a user via the terminal application 280 on selecting the LT 800 desired by the user, it sends an LT acquirement request to the second terminal device 102.

The license exchange unit 1903 of the second terminal device 102 receives the LT acquirement request from the first terminal device 102 (step S2402).

The license acquirement unit 242 of the second terminal device 102 confirms the presence/absence of the LT 800 requested from the first terminal device 102 (step S2403). More specifically, the license exchange unit 1903 passes the requested LT ID to the license acquirement unit 242 of the second terminal device 102. The license acquirement unit 242 of the second terminal device 102 searches the first secure DB 1902 in the second terminal device and checks whether the LT 800 with the LT ID is included or not.

When the answer of the step S2403 is YES, that is, when the requested LT 800 is included, step S2404 is executed.

When the answer of the step S2403 is NO, that is, when the requested LT 800 is not included, as it is impossible to send and receive the LT 800, the second terminal device 102 sends the notification of incapability of sending the LT to the first terminal device 102 and executes the step S2409.

The license acquirement unit 242 of the second terminal device 102 judges whether the history logs of the acquired LT 800 are included or not (step S2404). More specifically, the license acquirement unit 242 of the second terminal device 102 judges whether a history log tag block 1105 as shown in FIG. 11 is included in the acquired LT 800 or not.

When the answer of the step S2404 is YES, that is, when history logs are included in the LT 800, step S2405 is executed.

When the answer of the step S2404 is NO, that is, when history logs are not included in the LT 800, step S2407 is executed.

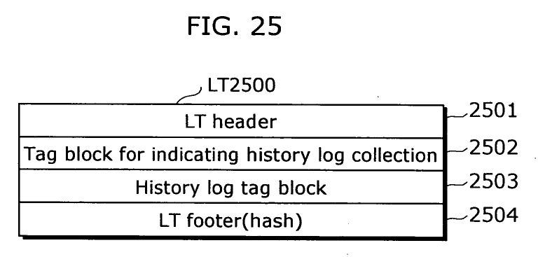

The license acquirement unit 242 of the second terminal device 102 divides the history logs included in the LT 800 (step S2405). More specifically, the license acquirement unit 242 of the second terminal device 102 takes the history log tag block 1105 from the LT 800 and generates a new LT 2500 for sending history logs as shown in FIG. 25. This LT 2500 includes only an LT header 2501, a tag block for indicating history log collection 2502, a history log tag block 2503 and an LT footer 2504 as shown in FIG. 25, but it does not include either an LT action tag block 1102 or a content key tag block 1103 shown in FIG. 11. Therefore, it is impossible to use the content using the LT 2500. The LT 800 from which the history log tag block 1105 is taken is passed to the license exchange unit 1903 of the second terminal device 102 so as to be sent to the first terminal device 102.

The license acquirement unit 242 of the first terminal device 102 stores the LT 2500 in which only history logs are recorded in the first secure DB 1902 of the second terminal device 102 (step S2406).

The license exchange unit 1903 of the second terminal device 102 sends the LT 800 to the first terminal device 102 (step S2407).

The license exchange unit 1903 of the second terminal device 102 receives the LT 800 from the second terminal device 102 (step S2408). More specifically, the license exchange unit 1903 of the first terminal device 102 receives the LT 800, passes the LT 800 to the license acquirement unit 242 in the first terminal device 102 and stores the LT 800 in the first secure DB 1902 of the first terminal device 102.

Note that the LT 2500 in which only history logs are recorded is sent to the right management server 101b at predetermined timing according to the history log response condition 2005 written in the tag block for indicating history log collection 2502 in the step S2406. At that time, it is possible to send the LT 2500 after excluding the tag block for indicating history log collection 2502 so as to reduce the size of data to be sent.

Also, when the second terminal device 102 sends the notification of incapability of sending LT to the first terminal device 102, the first terminal device 102 receives the notification of incapability of sending LT (step S2409). More specifically, the license exchange unit 1903 of the first terminal device 102 receives the notification of incapability of sending LT from the license exchange unit 1903 of the second terminal device 102 and notifies the user of the processing via the user interface unit of the terminal application 280 so as to finish this processing.

It is supposed that, in the processing shown in FIG. 24, as to the content use control, the LT 800 acquired from the second terminal device 102 is an LT 800 which is unprocessable in the first right management unit 1900 in the first terminal device 102 but processable only in the second right management unit 1920. In other words, it is the LT 800 whose LT action tag block 802 and content key tag block 803 are processable only by the second right management unit 1920. In this case, the LT 800 needs an identifier for showing which right management unit (the first right management unit 1900 or the second right management unit 1920 in FIG. 19) is capable of processing all or part of the LT 800.

When using the content using this LT 800, the LT 800 is read out from the first secure DB 1902 and sent to the second content use control unit 1921 via the first content use control unit 1901 and processed in the second content use control unit 1921. The second content use control unit 1921 sends the content key to the content use unit 250, records the history logs according to the conditions written in the tag block for indicating history log collection 1104 of the LT 800 and sends the history logs to the third history log collection unit 1923. The history logs acquired in the third history log collection unit 1923 are sent to the first history log collection unit 245 and sent to the right management server 101b.

Also, the timing for sending the history logs specified by the right management server 101b to the terminal device 102 may be determined depending on the capability of the terminal device 102. For example, in the case of a terminal device 102 which does not have either the first secure DB 1902 or the second secure DB 1922, there is a conceivable method by which it is indicated that history logs are sent to the right management server 101b immediately after they are recorded. In contrast, in the case of a terminal device 102 which has either the first secure DB 1902 or the second secure DB 1922, there is a conceivable method by which it is indicated that history logs are sent to the right management server 101b when a certain number of history logs are stored in the first secure DB 1902 or in the second secure DB 1922 or when it gets a certain time. Another conceivable method is by indicating that history logs of highly reliable users such as heavy users should be sent earlier because these history logs are immediately collected but history logs of general users should be sent after a certain time lapses.

An example case where the content use time is specified by absolute time information in the target content part 2003 shown in FIG. 20, but it is possible to specify the content use time by relative time information (information on the elapsed time needed to read out the content starting from the head to the present location of the content).

In addition, the third history log collection unit 1923 may be sent history logs directly to the right management server 101b not via the right management unit 240 or acquire an LT from the right management server 101b in the terminal device 102. It is needless to say that the second right management unit 1920 needs to include a license acquirement unit for acquiring LTs, a history log sending unit for sending history logs to the right management server 101b, a sending and receiving unit for communicating with the distribution center 101 and the like in this case.

As mentioned up to this point, the content history log collecting system 2 is capable of dispersing the upload timings to the right management server for each terminal device, and thus it becomes possible to reduce a deluge of accesses to the right management server. Also, as it is possible to send license exchange history logs between the terminal devices to the server, the service provider can trace the license transfer between the terminal devices.

It is indicated that indication information for collecting history logs and history logs are set in the LT in the first and the second embodiments in the present invention, but a setting is not limited to the case, it is possible to send and receive indication information for collecting history logs or history logs between the distribution center 101 and the terminal device 102 using a data construction except the LT. In addition, it is possible not to use any LT when it is the sudden indication for collecting history logs or a collection indication of history logs that is not “for each content” even when using an LT.

Also, the data such as LTs, history log collection indications and, history logs shown in the first and the second embodiments of the present invention may be binary information, the one which is written in script language such as XML and the like, electronic watermark or the like.

Also, an example case where an LT is composed of a tag block for indicating history log collection and a history log tag block is shown in the first and the second embodiments in the present invention, but the setting is not limited to the case, it is possible to include, in the LT action tag block, the history log collection indication used by the content use unit.

Also, when the capacity of the secure DB in which history logs are stored is not enough in the first and the second embodiments in the present invention, it is possible to immediately send the history logs in the secure DB to the right management server 101b, immediately sends them to the right management server 101b by generating the LT for sending the history logs that are being recorded or stop collecting the history logs. In any case, the right management server 101b can judge that the user should be excluded from target users of the history log collection from next time by notifying the right management server 101b of the fact that the capacity of the secure DB is not enough. Also, when the problem that the capacity of the secure DB is not enough is solved, the right management server 101b can judge that the user should be included in the target users of the history log collection again by notifying the right management server 101b of the fact that the problem is solved.

Also, the terminal device 102 may determine the timing for sending history logs in the first and the second embodiments of the present invention. For example, it becomes possible to disperse the timings for sending history logs to the right management server 101b by dispersing the timings for sending history logs to the right management server 101b using unique information (such as a terminal ID) of the terminal device 102. Also, the terminal device 102 can determine the timing for sending history logs according to the capability of the terminal device 102. For example, it becomes possible to determine the timings for sending history logs considering the loads of the right management server 101b, the terminal device 102 and the network 103 according to the presence/absence of the secure DB of the terminal device 102, the remaining capacities of the secure DB and the like.

Also, an example case where conditions for collecting history logs are managed for each content in the right management server 101b in the first and the second embodiments in the present invention, and the case where conditions for collecting history logs are managed for each user or as a whole system are also conceivable. In both cases, either collecting history logs for each content or collecting history logs of a plurality of contents together may be executed.

Also, an example case where the right management server 101b sends an indication for collecting history logs or collects history logs in the first and the second embodiments in the present invention, a server is not limited to the case, a server device that does not manage use conditions (which means that it does not have any use condition DB) may be used.

Also, the right management server 101b sends a condition that indicates history log collection in the first and the second embodiments in the present invention, there is no need to send all of these pieces of information, it is possible to hold them previously as default values in the terminal device 102 and record or send the history logs according to these conditions.

Also, an example case where contents, licenses, value information and the like are fetched from a single distribution path in the first and the second embodiments in the present invention, it is possible to fetch information via a plurality of distribution paths, for example, using both digital broadcasting or a package medium and the Internet concurrently.

As to a use method of history logs collected by the distribution center 101, the following methods are conceivable by analyzing history logs:

1. History logs are utilized for producing programs or contents which are desired by users.

2. History logs are utilized for scheduling programs effectively by analyzing users' tastes such as scenarios, dramatics, characters and the like in detail and associates these pieces of information with the date and time of broadcasting and viewers' information.

3. History logs are utilized in deciding rates of CM broadcasting for each time frame by collecting viewer ratings of CMs.

4. History logs are utilized for charging a client based on the viewer rating of the CM.

5. History logs are utilized for promoting programs (contents) or improving each user's ratio of contacting with a program by disclosing the analysis results to users.

6. History logs are utilized for giving users privileges based on the history logs. For example, it is conceivable that a discount is given to regular users based on their history logs.

7. History logs are utilized for distributing a profit to an owner of copyright and the like based on history logs.

8. History logs are utilized for controlling, using and designing server devices based on history logs. For example, they can be utilized for controlling, using and designing server devices for the future by analyzing users' tendencies to access servers based on history logs.

9. History logs are utilized for providing users a function as a reminder by allowing users to refer to their history logs. History logs are also utilized for recommending certain contents to certain people such as users' friends and family members by disclosing users' history logs to them.

### INDUSTRIAL APPLICABILITY

The present invention is suitable for a server device for distributing digital contents such as video, music and the like and licenses of digital contents using a communication network or broadcasting and a terminal device for controlling the use of digital contents based on the licenses. For example, as a server device, it is suitable for a distribution server of a service provider for distributing digital contents via the Internet, a broadcasting device for broadcasting digital contents via broadcast and the like. Also, as a terminal device, it is suitable for a device for receiving digital broadcast such as a set top box, a digital TV, a DVD recorder and a hard disc recorder, a content playback device such as a personal computer and the like, a recording device or an apparatus including these devices.

What is claimed is:

1. A server device for providing a license to a terminal device for controlling content use based on the license, comprising:
a database unit operable to store collection conditions concerning history logs to be collected in the terminal device;
a generation unit operable to dynamically generate indication information according to the collection conditions stored in the database unit, the indication information indicating a request that the terminal device should collect history logs;
a sending unit operable to send the generated indication information to the terminal device; and
a receiving unit operable to receive history logs sent from the terminal device as a response to the indication information.

2. The server device according to claim 1,
wherein the database unit further stores a content use condition for each user of the terminal device,
the server device further comprises a license issuing unit operable to issue a license for permitting a user to use the content according to the use condition stored in the use condition database unit, and
the sending unit sends the license issued by the license issuing unit.

3. The server device according to claim 2,
wherein the database unit stores collection conditions for each content, and
the generation unit generates the indication information according to the collection conditions corresponding to the content permitted by the license issued by the license issuing unit.

4. The server device according to claim 3,
wherein the collection conditions relate to at least one of a content use date and time, a content use time duration in total content playback time, played back part of a content in a whole content and sub contents that construct the content.

5. The server device according to claim 3,
wherein the collection condition relates to a user profile who used the content, and
the user profile includes at least one of his/her sex, age and tastes.

6. The server device according to claim 3,
wherein the collection condition relates to an operation by a user who uses the content, and
the operation by a user includes at least one of playback, stop, forwarding, rewinding and pause.

7. The server device according to claim 3,
wherein the collection condition relates to the terminal device ID.

8. The server device according to claim 3,
wherein the collection condition relates to a content use state of a user who used the content, and
the content use state includes at least one of real time viewing, automatic recording and manual recording by a user.

9. The server device according to claim 3,
wherein the collection condition relates to a use state of the terminal device in which the content is used, and
the use state of the terminal device includes at least one of display resolution of the terminal device and the number of audio channels.

10. The server device according to claim 3,
wherein the collection condition relates to a service for providing the content, and
the service includes at least one of a video-on-demand program, a non-video-on-demand program and a package medium.

11. The server device according to claim 3,
wherein the collection condition relates to a combination of at least two conditions selected from a content use date and time, played back part of a content in a whole content, a user operation for using a content, a user profile, a user terminal device ID, a user ID, user's use state, a content use state and a content service providing state.

12. The server device according to claim 3,
wherein the collection condition includes a selection condition for specifying the terminal device from which history logs should be collected, and
the generation unit generates indication information to the terminal device that satisfies the selection condition.

13. The server device according to claim 12,
wherein the selection condition includes at least one of an explicit specification of the terminal device, a random selection, a selection based on a user profile and a selection based on past history logs.

14. The server device according to claim 3,
wherein the collection condition relates to a collection timing of history logs in the terminal device.

15. The server device according to claim 14,
wherein the collection timing includes at least one of at a certain time interval, for each content, for each unit of chapters that construct a content and for each user operation.

16. The server device according to claim 3,
wherein the collection condition relates to a timing for sending history logs collected in the terminal device to the server device.

17. The server device according to claim 16,
wherein the sending timing includes at least one of at a certain time interval, when a license is returned, for one or more user operation and for a certain number of collection times.

18. The server device according to claim 16,
wherein the collection condition is prescribed in a way that sending timings from a plurality of user terminal devices are dispersed.

19. The server device according to claim 3,
wherein the collection condition relates to a specification of the content whose history logs should be collection targets.

20. The server device according to claim 3,
wherein the sending unit sends the indication information together with the license to the terminal device.

21. A terminal device for controlling content use based on a license provided from a server device, comprising:
a receiving unit operable to receive indication information from the server device;
a collection unit operable to collect content history logs according to the received indication information; and
a sending unit operable to send the collected history logs to the server device.

22. The terminal device according to claim 21,
wherein the indication information includes at least two conditions selected from a content use date and time, played back part of a content in a whole content, a user operation for using a content, a user profile, a user terminal device ID, a user ID, user's use state, a content use state and a content service providing state.

23. The terminal device according to claim 21,
wherein the indication information includes a collection timing of history logs in the terminal device, and
the collection unit collects the history logs according to the collection timing.

24. The terminal device according to claim 21,
wherein the indication information includes a sending timing for sending history logs collected in the terminal device to the server device, and
the sending unit sends the history logs according to the sending timing.

25. The terminal device according to claim 21,
wherein the terminal device further comprises a database unit operable to store history logs collected by the collection unit securely, and
the sending unit sends the history logs stored in the database unit securely.

26. The terminal device according to claim 21,
wherein the indication information is sent from the server device together with a license for permitting the content use, and
the collection unit collects the history logs concerning content use permitted by the license.

27. A system comprising a server device for providing a license and a terminal device for controlling content use based on the license to be provided from the server,
wherein the server device includes:
a database unit operable to store collection conditions concerning history logs to be collected in the terminal device,
a generation unit operable to dynamically generate indication information indicating that the terminal device collects history logs according to collection conditions stored in the database unit,
a first sending unit operable to send the generated indication information to the terminal device; and
a first receiving unit operable to receive history logs to be sent from the terminal device as a response to the indication information, and
the terminal device includes:
a second receiving unit operable to receive the indication information from the server device;
a collection unit operable to collect contents history logs according to the received indication information; and
a second sending unit operable to send the collected history logs to the server device.

28. A history log collection method that makes it possible to provide a license for permitting content use in a server device so as to collect content history logs from a terminal device, comprising:
a generating step of dynamically generating indication information indicating the terminal device should collect history logs according to collection conditions stored in a database unit operable to store collection conditions concerning history logs to be collected in the terminal device;
a sending step of sending the generated indication information to the terminal device; and
a receiving step of receiving history logs to be sent from the terminal device as a response to the indication information.

29. A history log collection method for collecting content history logs in a terminal device in which a content is used based on a license to be provided from a server device, comprising:
a receiving step of receiving indication information from the server device;
a collection step of collecting content history logs according to the received indication information; and
a sending step of sending the collected history logs to the server device.

30. A history log collection method for a server device to collect content history logs from a terminal device in a system comprising the server device for providing a license and the terminal device for controlling content use based on the license to be provided by the server device, the history log collection method comprising:
a generation step of dynamically generating indication information indicating that the terminal device collects history logs according to collection conditions stored in a database unit for storing collection conditions concerning history logs to be collected in the terminal device;
a first sending step of sending the generated indication information to the terminal device in the server device;
a second receiving step of receiving the indication information from the server device in the terminal device;
a collection step of collecting content history logs according to the received indication information in the terminal device;
a second sending step of sending the collected history logs to the server device in the terminal device; and
a first receiving step of receiving history logs to be sent from the terminal device as a response to the indication information in the server device.

31. A program for a server device to collect content history logs from a terminal device, the server device providing a license for permitting content use and the program having a computer in the server device execute the following steps:
a generation step of dynamically generating indication information indicating a request that the terminal device should collect history logs according to the collection conditions stored in a database unit for storing collection conditions concerning history logs to be collected in the terminal device;
a sending step of sending the generated indication information to the terminal device; and
a receiving step of receiving history logs to be sent from the terminal device as a response to the indication information.

32. A program for collecting contents history logs in a terminal device in which a content is used based on a license to be provided from a server device, the program having a computer in the server device execute the following steps:
a receiving step of receiving indication information from the server device;
a collection step of collecting content history logs according to the received indication information; and
a sending step of sending the collected history logs to the server device.
